(19) United States
(12) Patent Application Publication
(10) Pub. No.: US 2005/0113113 A1
(43) Pub. Date: May 26, 2005

(54) Enhanced wireless phone

(76) Inventor: Mark Jefferson Reed, Tucson, AZ (US)

Correspondence Address: Mark E. Ogram, Ste 203, 7454 E. Broadway, Tucson, AZ, 85710, US

(21) Appl. No.: 10/389,637

(22) Filed: Mar. 14, 2003

Related U.S. Application Data
(63) Continuation-in-part of application No. 10/186,503, filed on Jul. 1, 2002, now abandoned.
(60) Provisional application No. 60/335,228, filed on Nov. 15, 2001.

(51) Int. Cl. H04Q 7/20

(52) U.S. Cl. 455/456.3

(57) ABSTRACT

A communication system which communicates messages between telephones. A data storage mechanism includes data specific to a locale of the communication network. A mobile phone has the ability to identifying its specific location of said mobile phone, and, withdrawing data from the data storage means via the communication network.

This is a continuation-in-part of U.S. patent application Ser. No. 10/186,503 filed on Jul. 1, 2002, and entitled Multi-Function Wireless Communications Device; which was a regular patent application of provisional patent application No. 60/335,228, filed on Nov. 15, 2001, by Mark Jefferson Reed for A MACH[NE FOR PROVIDING A MULTI-FUNCTION WIRELESS COMMUNICATIONS DEVICE AND PROCESS FO MAKING SAME, and from which applicant claims priority.

### BACKGROUND OF THE INVENTION

The present invention relates to a wireless communications device. More particularly, the present invention relates to a multi-function wireless communications device.

The use of wireless communications devices in society has become of great importance. In an increasingly mobile society, the use of these devices has increased the productivity and efficiency levels of entire nations due to the improved ability for citizens to communicate on an instantaneous basis. As technology has progressed, the ability to miniaturize circuitry has increased, while the cost of implementing this technology continues to decline. This phenomenon creates a great opportunity for the evolution of the wireless communications device to comprise more useful features, which can be integrated into a fully self-contained wireless communications device's handset. Indeed, many advanced features are now available on wireless communications devices which set the landscape for the integration of additional useful and novel features.

The integration of Personal Digital Assistants (PDA's) into a wireless communications devices is taught by U.S. Pat. No. 5,797,089 to Nguyen.

Interactive display screens which can be used as keypads/keyboards or as a monitor similar to a TV screen, are known in the prior art. The ability, however, to add, delete, or change function controls (keypads/keyboards or other) on the interactive display screen by the user, a manufacturer, or a service provider through a wireless interface or other components of a wireless communications device is needed.

Voice recognition software, which allows the user of a wireless communications device to perform basic phone functions such as dialing a number is known in the prior art, as taught by U.S. Pat. No. 6,157,848 to Bareis et al.

U.S. Pat. No. 6,157,848 to Bareis et al. teaches a telecommunications system for the recognizing of spoken commands over a cellular telephone, satellite telephone, or personal communications network. In the cellular application, for example, a speech recognition system interconnects either internally with, or as an external peripheral to, a cellular telecommunications switch. The speech recognition system includes an administrative subsystem, a call processing subsystem, a speaker-dependent recognition subsystem, a speaker-independent recognition subsystem, and a data storage subsystem. The speech recognition system also allows for increased efficiency in the cellular telephone network by integrating with the switch or switches as a shared resource. The administrative subsystem of the speech recognition system is used to keep statistical logs of pertinent call information. Pre-recorded instructional messages are stored in the memory of the call processing subsystem for instructing a user on his or her progress in using the system. The speaker-independent recognition subsystem allows the user to interact with the system employing non-user specific functions. User specific functions are controlled with the speaker-dependent recognition subsystem. User specific attributes collected by the recognition subsystems are stored in the data storage subsystem.

The ability, however, to use and integrate the voice recognition software, which is contained within the handset of the wireless communications device, into other applications and components of the phone such as, for example, word processing, facsimile preparation, memos, translation of telephone conversations from the spoken word into data, and many other similar applications would be useful and provide a novel feature. This feature, would, for example, allow a deaf person to participate in a telephone conversation by allowing them to read the words that are being spoken by the caller on the display screen of the wireless communications device.

Facsimile capabilities, which allow the user of a wireless communications device to send and receive facsimiles, is known in the prior art. The integration, however, of voice recognition software would greatly improve the convenience of preparing and sending facsimiles. Also, the convenience and safety of receiving a facsimile transmission would be greatly increased with the integration of voice recognition programs combined with optical character recognition programs and texts/voice read-up software/hardware, which would allow the facsimile to be read to the user through the earpiece of the wireless communications device, view that facsimile transmission on the interactive display screen, and import the facsimile transmission into other applications such as word processing, e-mail, etc.

Video cameras for recording of images, which can be downloaded from a wireless communications device to devices external to the wireless communications device, are known to exist in the prior art, as taught by U.S. Pat. No. 6,192,257 to Ray.

U.S. Pat. No. 6,192,257 to Ray teaches a wireless communication terminal that is configured for enabling a user to receive and transmit video images as well as receive and transmit audio or speech signals associated with the user of the terminal and another user at, for example, a remote location. The received video image is obtained from a video image signal received over a radio frequency communications link established between the wireless communication terminal and a cellular base station. This received video image is displayed in a video image display conveniently associated with the wireless communication terminal. The transmitted video image signal may be that of the user of the terminal, of a scene within the field of view of the video camera or of text either coupled to the terminal through one of many well known data interfaces, or an image of text as captured by the camera. This transmitted video image signal is obtained from a video camera associated with the wireless communication terminal and then transmitted over the radio frequency communications link established between the wireless communication terminal and the cellular base station for displaying in a remotely located video image display.

The placement, however, of the camera lens on the handset is awkward under current configurations.

Still digital cameras, which allow the downloading of images to devices of a wireless communications device, are known in the prior art. The ability, however, of the digital camera's lens to function as the input source for scanner hardware/software applications would be a useful and novel feature. Also, the shape and placement of the cameras lens are awkward under current configurations.

Scanners, which allow for scanning bar coded items, are know in the prior art. The use of scanners, however, to scan texts into a wireless communications device, combined with an optical character recognition program for other applications such as, for example, word processing, faxing, e-mailing and many other applications would be a useful and novel feature.

Voice mail systems/answering machines, which are contained within a single handset housing of a wireless communications device, allow the user to transfer incoming calls when the user is not available is known in the prior art, as taught by U.S. Pat. No. 5,867,793 to Davis.

U.S. Pat. No. 5,867,793 to Davis teaches a cellular telephone with a message recorder built into its handset for conveniently recording selected portions of a cellular telephone call. In the preferred embodiment, the message recorder is a digital type message recorder which includes control buttons located on the handset which enable the user to selectively record, play, rewind, forward, and erase messages. The message recorder is connected to the cellular telephone's earpiece so that the recorded message can be played back therethrough for greater privacy and improved hearing. An optional switch is connected between the cellular telephone circuit and the handset's microphone so that a message spoken into the microphone may be recorded.

These voice mail/answering machines, however, do not comprise or interface with voice recognition software or optical character recognition application. This would be a useful and novel feature because it would allow, for example, for a caller's message to be displayed in a text format on the interactive display screen, without the added step of retrieving the message. This would be useful to deaf people, or for people in a situation, such as a meeting, a movie, a restaurant, etc. where it is not convenient to receive calls. The voice recognition software would also allow for the translated text message to interface with other applications such as, for example, facsimile, e-mail, word processing etc. In addition, these voice mail/answering systems do not take into account the geographic location of the wireless communications device or if an external voice mail system is available in the geographic location.

Global Positioning System (GPS) equipment has been integrated into the handsets of fully self-contained wireless communications devices, as taught by U.S. Pat. No. 5,497,339 to Bernard.

U.S. Pat. No. 5,497,339 to Bernard teaches a communication device for a personal digital assistant (PDA). The PDA mounts within the communication device and the communication device connects electronically to a serial port on the PDA Through this single serial port, the communication device provides the user of the PDA with access to multiple communication media, such as a telephone modem, a global positioning system engine, a packet radio, and a cellular telephone. Data from the PDA is directed to a decoder that routes the data to the appropriate communication medium, while data from the communication media are multiplexed onto the single serial interface of the PDA The communication device also provides a pass-thru serial interface that allows other external devices to communicate directly with the serial port of the PDA In addition, the communication device can upload software to the PDA that facilitates communications between the PDA and the communication device and allows the PDA to control the operation of the communication device.

GPS technology, however, has limitations due to the need for access to an unobstructed sky. These types of devices do not function while inside of buildings. The ability of wireless communication devices to determine its geographic location through the examination of, for example, available radio frequencies, using such available information as time difference of arrival (TDOA), signal strength, triangulation of radio towers, etc., and then to integrates this location information into other applications either internal or external to the wireless communication device is also high in the prior art. One example which teaches different techniques for allowing a wireless communication device to determine its own location is taught by U.S. Pat. No. 6,252,544.

A hierarchy of user location methods provides a wireless communications device with a means to select the best location method or combination of methods from a plurality of user location methods depending on what information is available to the wireless communications device and the needs of the application using the information. The ability for the wireless communications device to determine its geographic location and to use this geographic location information in other applications would be useful and a point of novelty.

Roaming features, which allow a wireless communications device to select an optimum wireless communications network when the wireless communications device roaming outside of its home network, is known in the prior art, as taught by U.S. Pat. No. 5,832,367 to Bamburak et al., U.S. Pat. No. 6,085,085 to Blakeney II et al., and U.S. Pat. No. 6,141,551 to Guruparan et al. These roaming systems operate by utilizing data (HLR/VLR, etc.), which is transmitted in the radio frequency signal sent to and from the wireless communications device.

U.S. Pat. No. 5,832,367 to Bamburak et al. teaches a communication device that locates a wireless service provider in a multi-service provider environment using a frequency band search schedule. The frequency band search schedule has a first or home band and several other frequency bands in a predetermined order. The order of the frequency bands may be programmed by the user or by a home service provider over the air. The communication device searches for an acceptable service provider by examining the home band and then the other bands listed in the frequency band search schedule. The bands are examined in the order specified by the frequency band search schedule. An acceptable service provider is identified by comparing the identity of a service provider specified by an identifier received from a band being examined with a list of acceptable service providers.

U.S. Pat. No. 6,085,085 to Blakeney II et al. teaches a method and apparatus for selecting a communication system in accordance with the geographic region in which the subscriber station is located. Upon successful acquisition, the subscriber station examines the received system identification information to determine its geographical region. The subscriber station then determines whether the acquired system is the most desirable system for use in the geographical region. If it is the most desirable system for use in the geographical region, the subscriber station provides service using the acquired system. If it is not the most desirable system for use in the geographical region, the subscriber station attempts to acquire a more desirable system.

U.S. Pat. No. 6,141,551 to Guruparan et al. teaches a mobile communications device that is selectively in communication with a radio telecommunications system having an authorized service provider and an unauthorized service provider, each service provider with a control channel associated therewith. A method for managing the communication between the device and the system involves the steps of detecting control channels received by the mobile communications device, determining whether the control channels received by the mobile communications device are associated with an authorized or an unauthorized service provider, storing an authorization code representative of whether the control channels received by the mobile communications devices are associated with an authorized or an unauthorized service provider, in response to receiving a request to initiate communication between the mobile communications device and the radio telecommunications system, selecting one of the control channels received by the mobile communications device to initiate communication between the mobile communications device and the radio telecommunications system, determining the authorization code associated with the one of the control channels, and enabling communication between the mobile communications device and the radio telecommunications system only if the authorization code associated with the one of the control channels is associated with an authorized service provider.

The use, however, of radio frequency signals to determine the location of a wireless communications device is not as accurate as the use of a GPS system within a wireless communications device. The use of a GPS system within a wireless communications device is taught by U.S. Pat. No. 5,396,647 to Thompson et al.

U.S. Pat. No. 5,396,647 to Thompson et al. teaches a communication device that operates in a wide area communication system having a number of sites. The communication device includes a first receiver for receiving communication signals from an active site. The information received from the active site includes the location information and the quality of the adjacent sites. The communication device includes a GPS receiver for establishing its own location. The location of adjacent sites along with their quality is ranked to produce a ranking table. A controller is utilized to sense when the signal strength of the communication signals received from the active site falls below a desired level. The communication device switches to a new site on top of the ranking list when this condition of low signal strength is present.

Thompson et al., are limited to site selection within a single wireless communications network and do not take into account the need for switching and selecting an alternative wireless communications networks when roaming. Besides the use of GPS equipment, the user of a wireless communications device could also enter such geographical information such as, for example, name of city or zip code in order to facilitate the roaming process. Triangulation of public radio and television station broadcast frequency information could also be used to facilitate the roaming process. This would be a useful and novel feature because it would facilitate the selection of an optimal service provider from a list of service providers within a geographical area when roaming and possibly assist in obtaining “service” instead of “no service” when roaming outside of the user's home wireless communications network. U.S. Pat. No. 6,198,941 to Aho et al. teaches a method of operating between two or more communications arrangements.

U.S. Pat. No. 6,198,941 to Aho et al. teaches a method of effectuating a change in the operation of a portable communication device such as a laptop or palmtop computer, a personal digital assistant (PDA), or a cellular telephone. The device can communicate with a remote host or server using one of two or more different communication arrangements. Various signals indicative of the environment in which the device is operating are monitored to anticipate or predict a change or transition from one communication arrangement to the other. If the change is determined to be both imminent and significant, the operation change is effected substantially simultaneously, by changing parameters in the transport and/or application protocol layer in the device.

Aho et al., however, relate to changing of communications arrangements between a local service provider and a communications system within a building which enables the commune wireless communications device to be transported from outside of a building to inside a building, and the ability to adapt to change in the communications system. They also do not teach how to select a service provider within a plurality of service providers based upon such criteria, for example, as cost of service or roaming, and the use and agreements which may exist between the user's home network and other networks.

Recording abilities, which allow the user of a wireless communications device to record telephone conversations is known in the prior art. A voice recorder system is taught by U.S. Pat. No. 5,995,824 to Whitfield.

U.S. Pat. No. 5,995,824 to Whitfield teaches a telecommunications system and method for providing cellular phone voice recording to subscribers, in order to simplify the recording of information while using a mobile terminal, and to increase the safety of the subscriber while operating a motor vehicle. For example, during a call, a subscriber may initiate the recording feature by pressing a dedicated key or a sequence of keys on the cellular phone. This feature can be implemented completely within the cellular phone itself, or it can be implemented in the mobile services center/visitor location register (MSC/VLR). With this feature, a subscriber can record information at any time during a call without the need for recording materials, e.g., paper or the scratch pad function on the cellular phone, which both increases the safety of the subscriber while driving, and provides a convenient manner of recording information.

Wireless communications device's recording systems, however, do not take into consideration the legalities associated with recording laws, which vary from state to state and from country to country. What is needed, is the machine and method for a wireless communications device and/or a wireless communications device network, to respond appropriately and legally to the recording of telephone conversations by the user of the wireless communications device, depending upon its geographic location, which may be determined through a variety of methods, such as GPS, radio frequency data, data within the wireless communications network, etc. Also, these recording abilities, which are known in the prior art, do not include the use of voice recognition software/hardware, optical character recognition software/hardware, or text/voice read-up software/hardware which would enable the recorded conversations to interface with other applications such as, for example, word processing, e-mail, voice mail, facsimile transmissions, etc.

Scratchpad or memo recording capabilities are known in the prior art, as taught by U.S. Pat. No. 6,029,063 to Parvulescu et al.

U.S. Pat. No. 6,029,063 to Parvulescu et al. teaches a voice scratchpad implemented in a wireless telephone that allows the user to record important information gathered during a phone conversation. The wireless telephone includes signal processing means and memory means for recording at least one message or memo which is spoken over the telephone. The telephone also includes controls for initiating the recording of such a memo and for retrieving and replaying the memo. Indexing may be included which allows the system to record and replay a plurality of memos. The user of the phone can thus record important information in a memo on the voice scratchpad without the need for paper or the concentration and effort required for writing.

These electronic scratchpad and memo recording capabilities, however, do not take advantage of voice recognition software/hardware, optical character recognition applications, or text/voice read-up applications, which would allow such memos to be stored and used in a wider variety of applications, such as e-mail, facsimiles, word processing, etc.

Numerous other innovations have been provided in the prior art that will be described infra. Even though these innovations may be suitable for the specific individual purposes to which they address, however, they differ from the present invention.

FOR EXAMPLE, U.S. Pat. No. 5,297,183 to Bareis et al. teaches a telecommunications system for the recognizing of spoken commands over a cellular telephone, satellite telephone, or personal communications network. In the cellular application, for example, a speech recognition system interconnects either internally with, or as an external peripheral to, a cellular telecommunications switch. The speech recognition system includes an administrative subsystem, a call processing subsystem, a speaker-dependent recognition subsystem, a speaker-independent recognition subsystem, and a data storage subsystem. The speech recognition system also allows for increased efficiency in the cellular telephone network by integrating with the switch or switches as a shared resource. The administrative subsystem of the speech recognition system is used to keep statistical logs of pertinent call information. Pre-recorded instructional messages are stored in the memory of the call processing subsystem for instructing a user on his or her progress in using the system. The speaker-independent recognition subsystem allows the user to interact with the system employing non-user specific functions. User specific functions are controlled with the speaker-dependent recognition subsystem. User specific attributes collected by the recognition subsystems are stored in the data storage subsystem.

ANOTHER EXAMPLE, U.S. Pat. No. 5,400,393 to Knuth et al. teaches a digital telephone answering device (DTAD) that allows messages to be forwarded to certain internal mailboxes. Random access memory (RAM) is flexibly and dynamically controlled by a microprocessor or controller. Audio signals in the form of voice messages are digitized and stored in the RAM. Messages can be sorted and allocated to specific mailboxes and made retrievable by pressing a button assigned to that mailbox. Messages can also be moved or re-assigned from a common message area to a certain mailbox or mailboxes. Outgoing messages are also stored in RAM and can be of sufficient number to have an outgoing message correspond to each incoming message storage area. The normal message recording and message playback functions of the DTAD may be activated after the call has been answered on the receiving side.

STILL ANOTHER EXAMPLE, U.S. Pat. No. 5,428,671 to Dykes et al. teaches a modem which includes connections for both land lines and a cellular phone. The modem contains high and low level routines that allow it to perform standard AT commands rationally when connected to a cellular phone, and further perform additional AT commands that access cellular specific features. An applications software program in a computer connected to the modem can provide a number of options for determining whether to use the land line or the cellular phone when both are connected. First, it can default to the land line and only use the cellular phone if the land line is not available. Alternatively, it can first use the cellular phone and only use the land line if the cellular phone signal strength is not sufficient. Further, cellular file transfer operations can be aborted if the remaining battery life in the cellular phone is insufficient to reliably complete the transfer.

YET ANOTHER EXAMPLE, U.S. Pat. No. 5,711,012 to Bottoms et al. teaches a cellular interface that directly couples the speaker and microphone of a cellular telephone to a simultaneous voice and data (SVD) modem. This interface allows a cellular telephone user to use their cellular telephone for simultaneous voice and data communications over the cellular network. In addition, the SVD modem has a port coupled to a switched facility of a switching system. This cellular interface allows the cellular telephone user to place a telephone call from their cellular telephone over the switched facility.

STILL YET ANOTHER EXAMPLE, U.S. Pat. No. 5,781,857 to Hwang et al. teaches that a user, after accessing the communication system, selects a paged e-mail service option. In response, the communication system dispatches a service logic block to a service node proxy of an e-mail system. The service logic block is deposited in a site-specific service logic block repository of the e-mail system. An e-mail monitor is established for the e-mail system. Once established, the e-mail system sends an acknowledgment to the communication system. The user is then notified of receipt of the acknowledgment.

YET STILL ANOTHER EXAMPLE, U.S. Pat. No. 5,930,719 to Babitch et al. teaches a cordless system that comprises a laptop computer with a modem connected to a modem data port on a cordless telephone handset. A direct sequence spread spectrum RF link is established between the cordless telephone handset and a base station. Both the telephone network and a desktop computer with a modem are connected to the base station. When the cordless telephone handset detects that the laptop computer wants to go off-hook, a selection signal is also sent by the cordless telephone handset to the base station to indicate whether the call is to be directed to the telephone network or the desktop computer. When the base station detects that the desktop computer wants to go off-hook, a selection signal is also sent by the desktop computer to the base station to indicate whether the call is to be directed to the telephone network or over the RF link to the laptop computer. Incoming calls from the telephone network are directed to the desktop computer by the base station with a ring indication going to the cordless telephone handset. If the laptop computer answers the ringing, the cordless telephone handset indicates an off-hook condition to the base station and the base station routes the incoming call over the RF link to the cordless telephone handset and the laptop computer.

STILL YET ANOTHER EXAMPLE, U.S. Pat. No. 5,933,478 to Ozaki et al. teaches that in the handheld terminal device, when a message reception unit receives from a host computer a new arrival message indicating a new arrival of a file (or electronic mail), a control unit analyzes the new arrival message to obtain identifier information for identifying the file (or electronic mail) and a telephone number of the host computer. After a line connection to the host computer is established by a handheld phone transceiver unit, a fetch request command for fetching the file (or electronic mail) is transmitted to automatically fetch the file (or electronic mail) from the host computer and make the user know the contents of the file (or electronic mail) by using a display unit. A FAX transmitting user designates a destination handheld terminal device and transmits FAX image data to a communication server (CS). The CS stores the received FAX image data and transmits a FAX arrival message to a pager connected to the destination handheld terminal device. A user of the handheld terminal device informed of a FAX arrival by the pager confirms the FAX brief image data contained in the message, and if necessary, calls the CS by a handheld phone connected to the handheld terminal device to make the CS transmit the FAX image data and refer to the detailed contents thereof.

YET STILL ANOTHER EXAMPLE, U.S. Pat. No. 5,953,647 to Patel et al. teaches a mobile switching center (MSC) that includes a cellular modem pool that comprises a number of pairs of modems in which the data terminal equipment (DTE) ports of each modem pair are cross-connected in a “back-to-back” fashion. This allows the two modems of each pair to interchange data via their DTE ports and thereby isolate that portion of the cellular fax call over the cellular communications channel from that portion of the cellular fax call through the public-switched telephone network (PSTN). Fax information is transmitted over both the PSTN-portion of the cellular fax call and the cellular portion of the cellular fax call using standard fax modulation techniques. The cellular-side modem of each modem pair is adapted to recover fax handshaking and data signaling from the received—fax modulated—signal and translate the recovered fax information into non-modulated signals (e.g. AT commands) for application to the corresponding PSTN-side modem of the modem pair. The PSTN-side modem, in a similar fashion, is adapted to recover fax handshaking and data signaling from the received—fax modulated—signal and translate the recovered fax information into non-modulated signals for application to the corresponding cellular-side modem.

STILL YET ANOTHER EXAMPLE, U.S. Pat. No. 6,035,214 to Henderson teaches a laptop that has an integrated telephone, in which the telephone and mouse unit are arranged in a manner that allows the mouse to be adjusted to either side of the laptop computer to accommodate either a left-handed or right-handed person. A telephone is tightly integrated into the body of a laptop PC creating a more natural and ergonomic physical interface between the phone and the computer. The resulting device includes a mounting for the mouse module, allowing ease of use by both right-handed and left-handed users. The laptop computer includes a recessed storage area for the small telephone handset The storage area is located in the area just below the keyboard, i.e., the area where the user's wrists usually lie. The telephone handset and associated cable reside in the tray. The mouse module slides along a guide way in the tray and can be positioned on either side of the guide tray/telephone handset storage tray. The benefits of the above tight integration of the laptop PC and the telephone are many. First, one's laptop becomes one's telephone console. Second, the resulting telephone has local user programmable processing and a large storage area. Furthermore, the telephone has a large high resolution display. Moreover, integrating an IP telephone into the laptop allows communication over the same network IP links that the laptop communicates over normally. Finally, this does not preclude the inclusion of a standard PSTN telephone in the laptop.

YET STILL ANOTHER EXAMPLE, U.S. Pat. No. 6,073,034 to Jacobsen et al. teaches a microdisplay system that utilizes a small high resolution active matrix liquid crystal display with an illumination system and a magnifying optical system to provide a hand held communication display device. The system can employ an LED illumination system and cellular communication or processor circuits within a compact housing to provide communication devices such as pagers, telephones, televisions, and hand held computer or card reader devices with a compact high resolution data and/or video display.

STILL YET ANOTHER EXAMPLE, U.S. Pat. No. 6,178,331 to Holmes et al. teaches a bi-directional (and/or unidirectional) multiplexing messaging gateway for wireless devices, such as for devices using the global system for mobile communication (GSM) wireless digital standard, or any other suitable protocols. Electronic messages may be transmitted over a wireless connection to, or to and from, a mobile phone, and all necessary housekeeping functions are maintained and facilitated. For example, electronic messages addressed to a mobile phone may be received by the gateway of the present invention from the Internet, a LAN, or any other source, and routed to the appropriate mobile phone. Such electronic messages may be originated manually or may be automatically generated by specific computer applications, such as a scheduling program operating on a LAN. Likewise, the user of the mobile phone may reply to the sender of the original electronic message, whereby the gateway maintains the address of the sender and matches it with the reply so as to facilitate the forwarding of the reply to the correct address. Finally, the user of the mobile phone may cause an electronic message received from a sender to be remotely routed to, for example, a chosen facsimile machine, or any other suitable destination.

YET STILL ANOTHER EXAMPLE, U.S. Pat. No. 6,198,915 to McGregor et al. teaches a mobile phone system with a mobile phone having internal accounting capabilities for real time call debiting to account for the billing parameters of a mobile phone unit that is operated in a multi zone communication network with a complex rate structure. The mobile phone unit has an internal processor with accessible internal memory for storing the accounting program and call data for each call, and a clock and circuit means for activating and deactivating the phone. The accounting program includes an updatable rate table and a billing algorithm for calculating the account status on the fly including multiple rate structure factors such as long distance calls, international calls with country independent local charges, charges for roaming per day and/or roaming per minute, and call surcharges, where the account status of the mobile phone is calculated in real time for decrementing a debit account or calculating an account charge on demand. The mobile debit phone has a signal for alerting the user of account status which is preferably a display of real time account status. The mobile phone system includes a communication system for activating and programming a new phone unit over the airways and upgrading the account status and rate table in the phone unit over the airways.

It is apparent that numerous other innovations have been provided in the prior art that are adapted to be used. Furthermore, even though these innovations may be suitable for the specific individual purposes to which they address, however, they would not be suitable for the purposes of the present invention as heretofore described.

Even with the availability of such advanced features as has been previously mentioned, other features as discussed infra would be useful in wireless communications devices.

A call routing system which allows a wireless communications device to recognize the type of incoming transmission, i.e. voice, facsimile, video, etc., and route it to the appropriate hardware/software components comprised within the wireless communications device.

A download system, which allows a wireless communications device to download data and upload data to and from hardware/software within the wireless communications device and to devices external to the wireless communications device. This downloads system would enable a seamless flow of integration between all hardware/software applications comprised within the wireless communications device in real-time.

A memory storage management systems, which would allow a wireless communications device to upload/download and store memory, i.e. databases, application programs, files, etc. outside of the wireless communications device's single handset housing, through the use of wireless data transfers would be useful because this type of a memory storage management system would make up for shortcomings created by programs, databases, and other applications which require a larger memory than is contained within the wireless communications device and would also create an opportunity for sharing of data within a network.

Text/voice read-up hardware/software, which would allow for the transcription of texts into words would be useful, and which could be used in such applications as, for example, reading a received facsimile transmission through the earpiece of a wireless committee communications device or reading a scanned the text documents through the earpiece of the wireless communications device.

Language translation programs, which would allow for translation from one language to another, either within the single handset of a wireless communications device or within the wireless communications device network, would be useful since this language translation ability could then be integrated into a plurality of hardware/software applications, such as facsimile features, word processing, voice recognition programs, text/voice read-up programs, optical character recognition programs, telephone conversation translations, scanned text translations, and translation interfacing within other hardware/software applications internal or external to the wireless communications device.

A geographically based dialing system, which enables a call from a wireless communications device to be routed to a selected destination, for example, the closest customer service center, based on the location of the wireless communications device, are known in the prior art, as taught by U.S. Pat. No. 5,878,126 and U.S. Pat. No. 5,963,861. The routing of these calls to the appropriate location, however, is performed by equipment contained within the wireless communications network, but not within the wireless communications device. This creates a disadvantage because this feature would only work within the home network of the wireless communications network. What is needed is a machine and method, which would allow systems within the wireless communications device to dial an appropriate number based on the geographic location of the wireless communications device. This type of the system would be useful in such applications as a voice mail access, Internet access, customer service access, and any other type of dialing access where the appropriate number to be called would vary based on the user's geographic location.

A geographically based phone book database, which enables the user to find a selected business location based on the geographic location of the user are known in the prior arts, as taught by U.S. Pat. No. 5,964,821. This patent, however, pertains to a navigational apparatus witch is contained within a motor vehicle and furthermore is not a wireless communications device. What is needed is a machine and method which would allow the user of the wireless communications device to search for various phone book listings from a programmable and not datable database contained within the wireless communications device. The selected business listing would be determined based on the user's geographic location and would be a useful and novel feature. The location of the wireless communications device could be determined through a number of methods including, for example, GPS, radio frequency information, time difference of arrival (TDOA), user input, or other.

A geographic mapping apparatus, which would allow the user of a wireless communications device to plot their geographic location and use this information to interface with other applications, would also be a useful and novel feature. Such applications could include, for example, a trip route planning program, geographically based phonebook applications, and others.

An AM/FM, short-wave radio and television receiver contained within the handset of a wireless communications device would be a useful. Further, a wireless communications device comprising a geographically based tuning system, which allows for automatic tuning to radio and television frequencies as the wireless communications device moves from one location to another, would be useful.

A car stereo and/or onboard computer interfaces system, which would allow a wireless communications device to interact with a vehicles car stereo system and/or onboard computer system, would be useful and novel feature. This interface would comprise a cradle for the wireless communications device within the car stereo or onboard computer's hardware/software where such features as, for example, battery charging, uploading and downloading of data, sharing of programs and applications, a depository for the memory storage management system, speaker phone features, AM/FM, short-wave and television tuning based on geographic location and other applications could be facilitated.

Finally, the cross integration of these various hardware/software components would also produce some very useful and novel features within the single handset of a wireless communications device. These cross integrations may be achieved within the single handset of the wireless communications device or externally, via the assistance of the memory storage management system. This cross integration may use of a plurality of interfacing hardware/software applications or the cross integration may be achieved with the use of a single hardware/software application or a program comprising the necessary components to facilitate the desired outcome.

An example of this cross integration includes the ability to scan a document, which is written in a foreign language, through the scanner of a wireless communications device then importing that scanned texts into an optical character recognition program and then to a language translation program of the wireless communications device and then importing that translated text into a text/voice read-up program, with the possible assistance of the memory storage management system of the wireless communications device would give the ability to scan a book written in Spanish, for example, and have it be outputted in the form of spoken words in English, for example.

Another example of this cross integration includes the ability to receive a facsimile of a text document in a foreign language then to be able to process that document using optical character recognition and language translation programs so as to be able to be imported into a word processing program for editing would be a unique and novel cross integration of features that could be contained within the single handset housing of a wireless communications device.

### SUMMARY OF THE INVENTION

ACCORDINGLY, AN OBJECT of the present invention is to provide a multi-function wireless communications device that avoids the disadvantages of the prior art.

ANOTHER OBJECT of the present invention is to provide a multi-function wireless communications device that is simple to use.

BRIEFLY STATED, STILL ANOTHER OBJECT of the present invention is to provide a multi-function wireless communications device that includes a single handset housing, an alphanumeric keypad, an interactive display screen, and an antenna, all disposed on the single handset housing, a battery interface, a wireless telephone system, a computer system, a GPS system, an AM-FM short wave radio and television receiver, a radio frequency location system, a user location database, a navigational mapping system, a word processing program, a language translation program, a voice recognition program, a text voice read-up program, a facsimile/data system, a digital voice mail system, a recording system, a download system, a roaming system, a call routing system, a dialing phonebook system, a car stereo and onboard computer interface system, all contained within the single handset housing, and a scanner, a digital still camera, and a digital video camera, all contained within the single handset housing, but operable through the single handset housing.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawing are briefly described as follows:

FIGS. 1A-1G are a system chart of the multi-function communications device of the present invention.

FIG. 2 is a functional diagram of the invention.

FIGS. 3A and 3B are flow charts of the operation of an embodiment of the invention.

### LIST OF REFERENCE NUMERALISTILZIED IN THE DRAWING

10 multi-function wireless communications device of present invention
12 single handset housing
14 alphanumeric keypad
16 battery interface
18 interactive display screen
20 wireless telephone system
22 antenna
24 computer system
26 GPS system
28 AM-FM short wave radio and television receiver
30 radio frequency location system
34 user location database
36 navigational mapping system
38 word processing program
40 language translation program
42 voice recognition program
44 scanner
46 text voice read-up program
48 facsimile/data system
50 digital voice mail system
52 recording system
54 download system
56 roaming system
58 call routing system
60 dialing phonebook system
62 car stereo and onboard computer interface system
64 digital still camera
66 digital video camera

### DETAILED DESCRIPTION OF THE PREFERRED EMBODIMENT

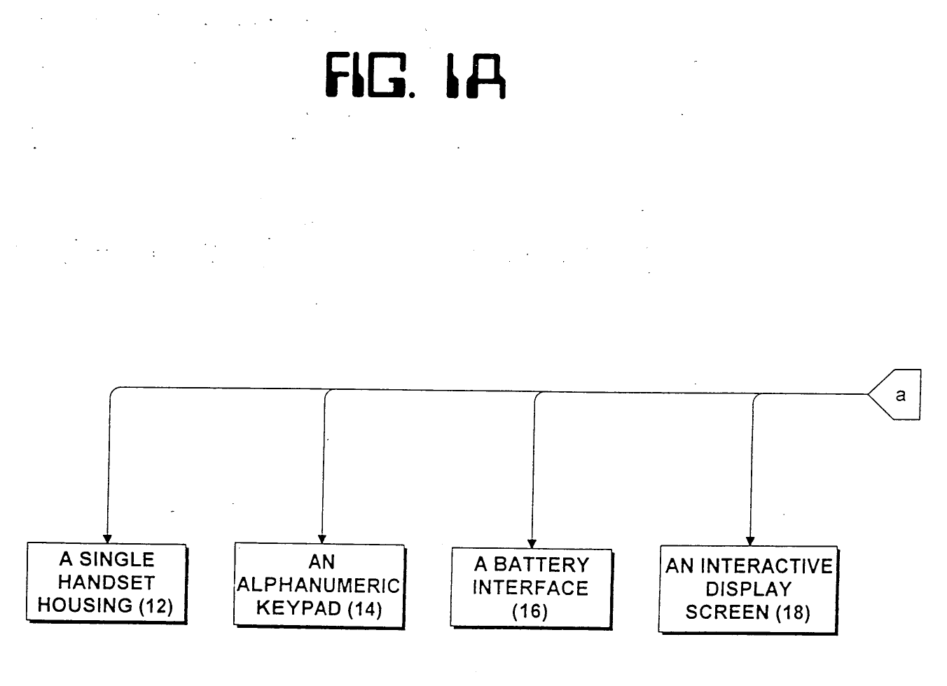

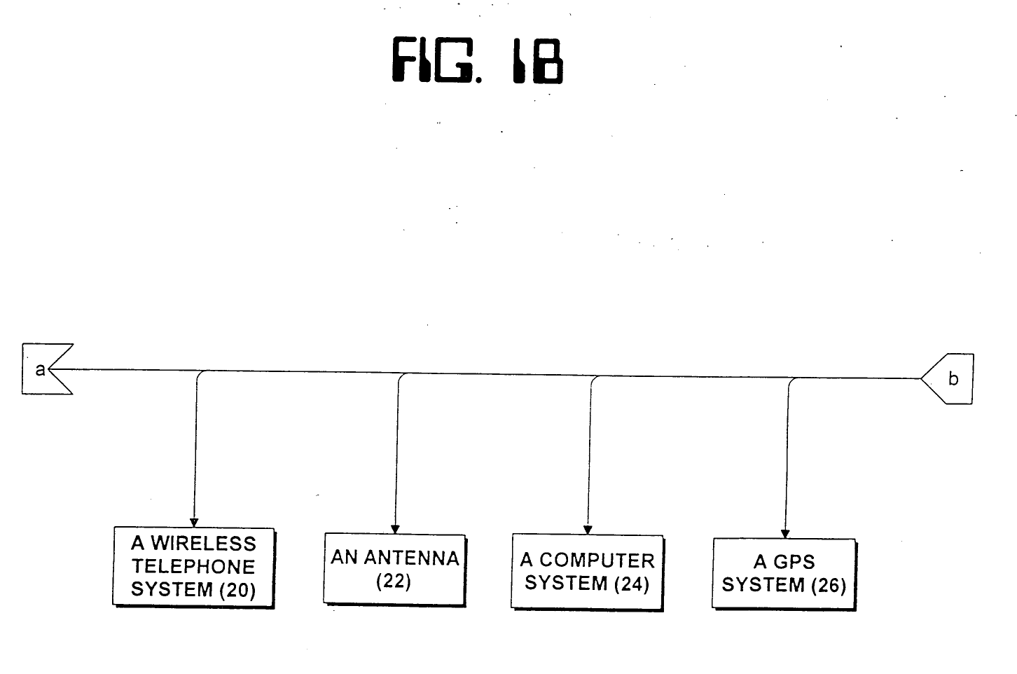

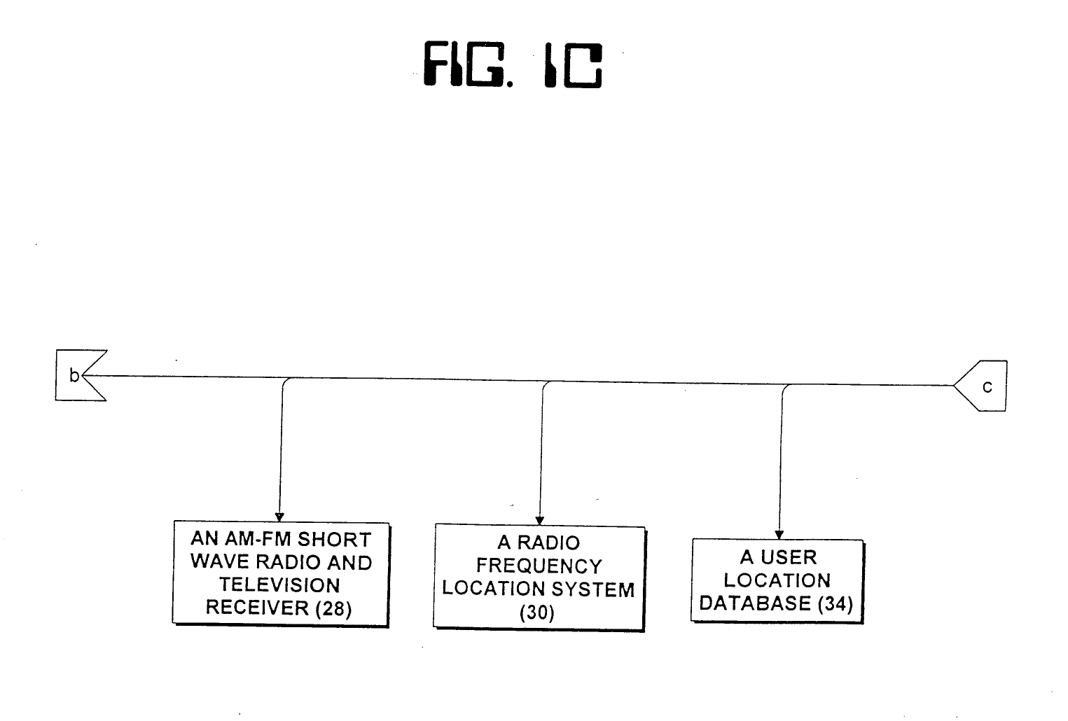

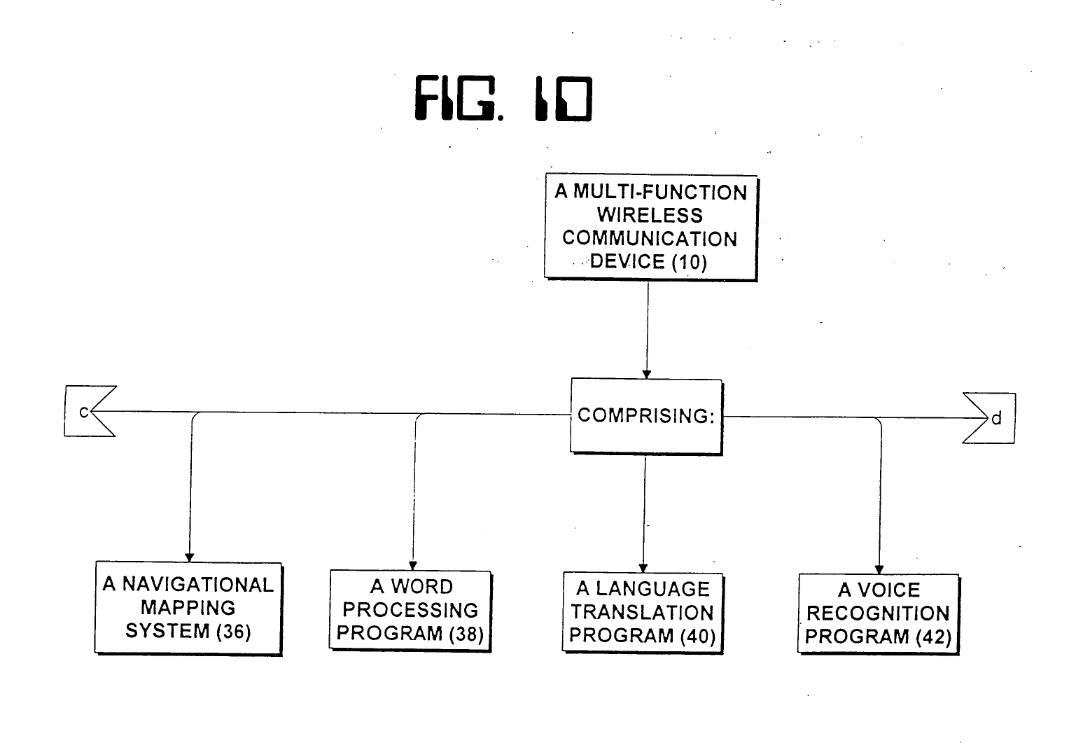

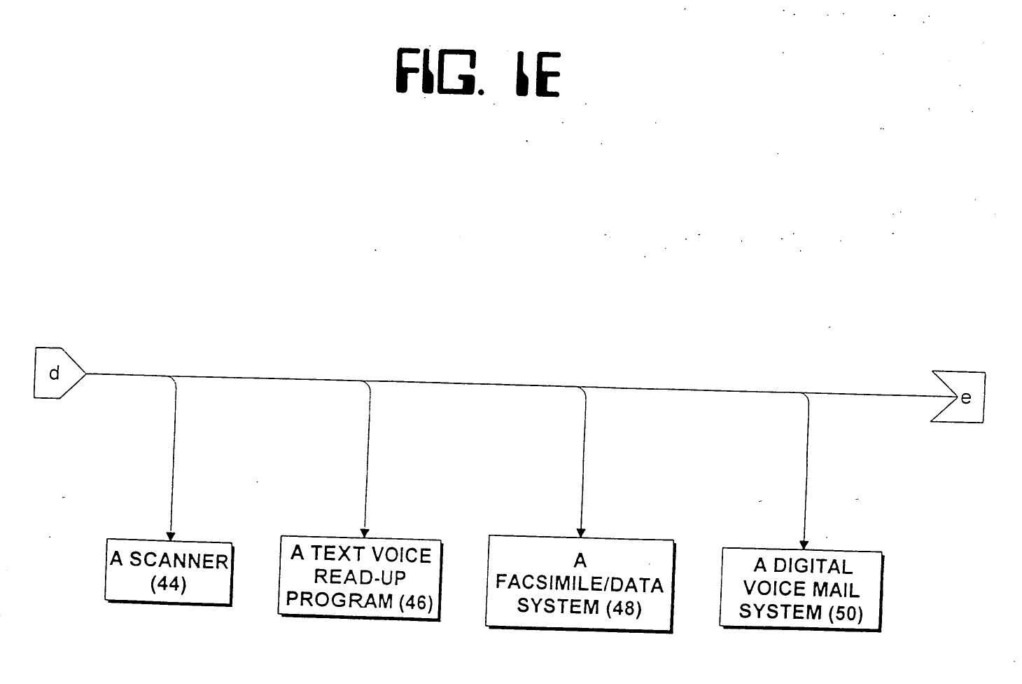

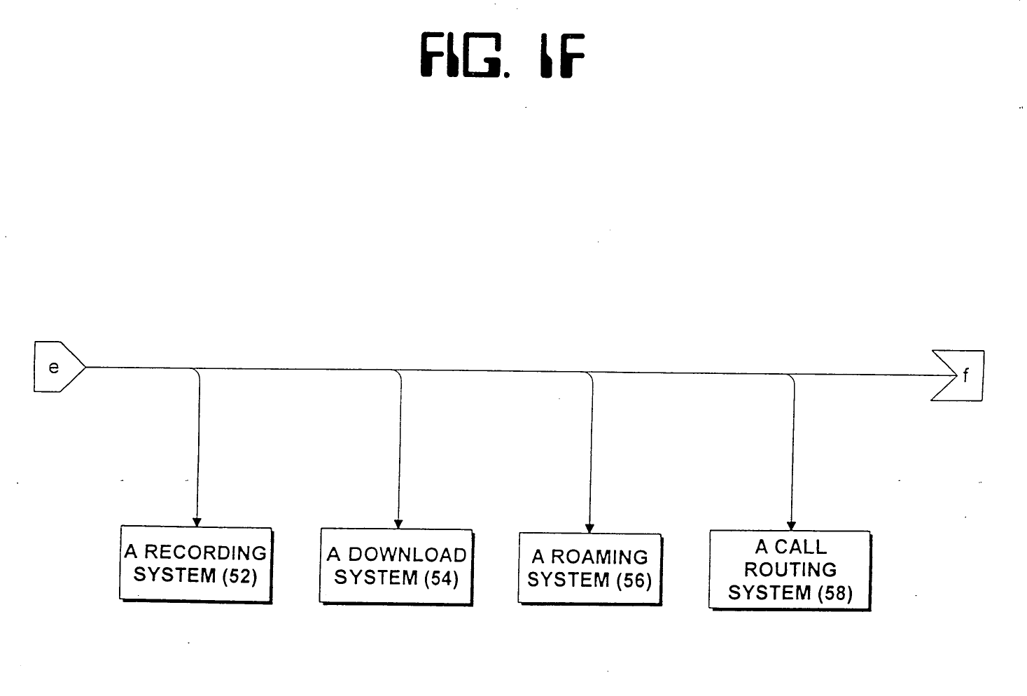

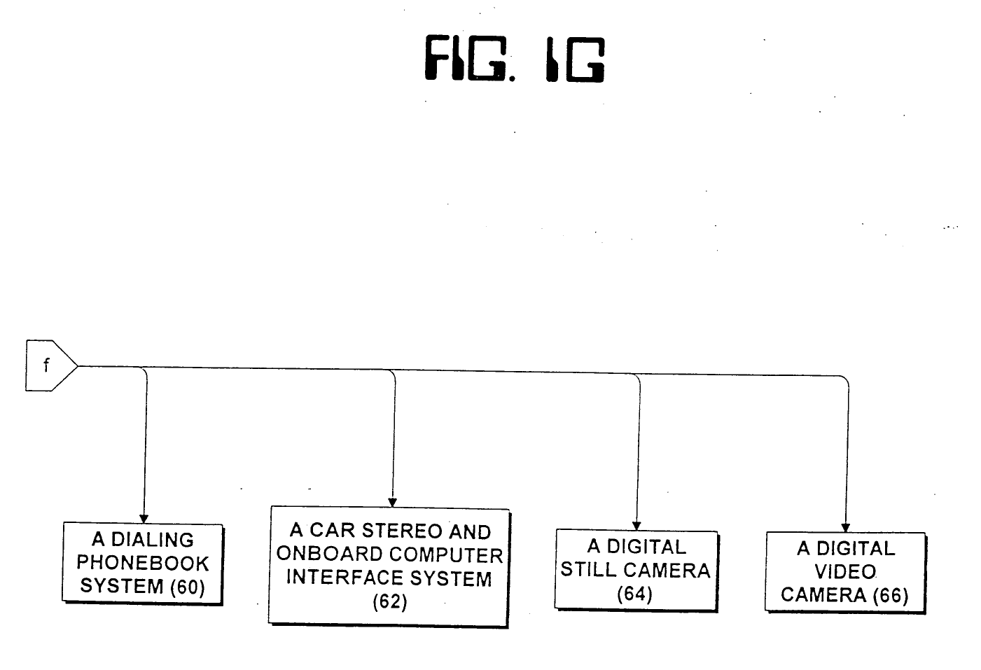

Referring now to the figures, in which like numerals indicate like parts, and particularly to FIGS. 1A-1G, which are a system chart of the present invention, the multi-function wireless communications device of the present invention is shown generally at 10.

The multi-function wireless communications device 10 comprises a single handset housing 12, an alphanumeric keypad 14 that is operatively disposed on the single handset housing 12, a battery interface 16 that is completely contained within the single handset housing 12 and holds a battery that powers the multi-function wireless communications device 10, an interactive display screen 18 that is disposed on the single handset housing 12 and is operatively connected to the alphanumeric keypad 14 and to the battery interface 16, a wireless telephone system 20 that is completely contained within the single handset housing 12, and an antenna 22 that is operatively connected to the wireless telephone system 20.

The interactive display screen 18 comprises function controls that are disposed either on the single handset housing 12 or on the interactive display screen 18 itself The function controls of the interactive display screen 18 comprise a finger mouse, a zoom in control, a zoom out control, a scroll up control, a scroll down control, a scroll right control, a scroll left control, a brightness adjustment control, a color adjustment control, and a vertical and horizontal hold control. The function controls of the interactive display screen 18 are added, deleted, or changed by a user, a manufacturer, or a service provider of the multi-function wireless communications device 10. The interactive display screen 18 is a keypad and/or a keyboard, and is navigated by a finger of the user, a pointer, the alphanumeric keypad 14, or the finger mouse.

The wireless telephone system 20 is operatively connected to the alphanumeric keypad 14, the battery interface 16, and the interactive display screen 18. The wireless telephone system 20 comprises a radio frequency, a primary carrier, a home calling area, an Internet service provider, an e-mail address, an earphone, and a mouthpiece. The earphone of the wireless telephone system 20 is completely contained within the single handset housing 12, but is audible through the single handset housing 12, and the mouthpiece of the wireless telephone system 20 is completely contained within the single handset housing 12, but is audibly accessible through the single handset housing 12.

The multi-function wireless communications device 10 further comprises a computer system 24 that is completely contained within the single handset housing 12. The computer system 24 comprises a processor, an operating system, standardization/conversion hardware/software, and a memory system. The memory system of the computer system 24 includes a ROM, PROM, RAM, a hard drive, a data port, a memory stick socket, a wireless data system, and a memory storage management system. The processor, the operating system, and the memory system of the computer system 24 are completely contained within the single handset housing 12, while the data port of the computer system 24 is also completely contained within the single handset housing 12, but is accessed through the single handset housing 12 and connects to devices that are external to the multi-function wireless communications device 10. The computer system 24 is operatively connected to the alphanumeric keypad 14, the battery interface 16, the interactive display screen 18, the wireless telephone system 20, and the antenna 22.

The standardization/conversion hardware/software of the computer system 24 is completely contained within the single handset housing 12, and is operatively connected to the alphanumeric keypad 14, the battery interface 16, the interactive display screen 18, the wireless telephone system 20, and the antenna 22. The standardization/conversion hardware/software of the computer system 24 standardizes and converts data received from devices external to the multi-function wireless communications device 10 to data that is standardized and converted to interface with the multi-function wireless communications device 10. The standardization/conversion hardware software of the computer system 24 standardizes and converts data to be sent to devices external to the multi-function wireless communications device 10 to data that is standardized and converted to interface with the external devices. The standardization/conversion hardware/software of the computer system 24 is programmed/updated by the user, a service provider, or a manufacturer of the multi-function wireless communications device 10 through the alphanumeric keypad 14, the interactive display screen 18, the wireless telephone system 20, or other components of the computer system 24.

The memory stick socket of the computer system 24 is completely contained within the single handset housing 12, but is accessed through the single handset housing 12. The memory stick socket of the computer system 24 is used with a removable memory stick that transfers data to and from devices external to the multi-function wireless communications device 10, and is supported by the computer system 24.

The wireless data system of the computer system 24 is operatively connected to the alphanumeric keypad 14, the battery interface 16, the interactive display screen 18, the wireless telephone system 20, the antenna 22, and all components of the computer system 24. The wireless data system of the computer system 24 comprises a wireless data port. The wireless data port of the wireless data system is accessed through the single handset housing 12 and transfers data to and from devices that are external to the multi-function wireless communications device 10.

The wireless data system of the computer system 24 further comprises an infrared data system. The infrared data system of the wireless data system sends and receives data through the wireless data port of the wireless data system to and from devices that are external to the multi-function wireless communications device 10 through an infrared signal. The wireless data system of the computer system 24 sends and receives data through the infrared data system of the wireless data system so as to form a wireless interface.

The memory storage management system of the computer system 24 is completely contained within the single handset housing 12. The memory storage management system of the computer system 24 is operatively connected to the alphanumeric keypad 14, the battery interface 16, the interactive display screen 18, the wireless telephone system 20, the antenna 22, and all components of the computer system 24.

The memory storage management system of the computer system 24 comprises a memory management program. The memory management program of the memory storage management system optimizes storage and transfer of memory from the multi-function wireless communications device 10 to and from external devices based on programmable circumstances, such as history of usage, file size, transfer speed, availability of external storage devices to transfer to, and user choice.

The memory management program of the memory storage management system is programmable as part of the memory storage management system of the computer system 24. The memory storage management system of the computer system 24 is programmed by the user, a manufacturer, or a service provider of the multi-function wireless communications device 10 through the alphanumeric keypad 14, the interactive display screen 16, the memory stick socket of the computer system 24, the data port of the computer system 24, and/or the wireless data system of the computer system 24. The memory storage management system of the computer system 24 uploads and downloads data from memory storage devices external to the multi-function communications device 10 by way of the computer system 24, hardware, software, firmware, wireless, the data port of the computer system 24, the memory stick socket of the computer system 24, the wireless data port of the wireless data system, and/or the wireless telephone system 20.

The memory storage devices that are external to the multi-function wireless communications device 10 comprise strategically placed wireless memory storage relay stations provided by a service provider, a palm held computer, another multi-function wireless communications device 10, an Internet web drive site, e-mail, voice mail, an onboard computer in a vehicle, an entertainment system in a vehicle, the wireless interface of the wireless data system with a service provider's memory storage device, the wireless interface of the wireless data system with a PC, a memory stick, a database, a printer, a fax machine, and other memory storage devices.

The multi-function wireless communications device 10 further comprises a GPS system 26 that is completely contained within the single handset housing 12. The GPS system 26 captures GPS data so as to form captured GPS data and records the captured GPS data in the memory system of the computer system 24 in the form of longitude and latitude coordinates. The captured GPS data is downloadable to other components and programs of the multi-function wireless communications device 10, and by other devices that are external to the multi-function wireless communications device 10. The GPS system 26 is supported by the computer system 24, and is operatively connected to the alphanumeric keypad 14, the battery interface 16, the interactive display screen 18, the wireless telephone system 20, the antenna 22, and all components of the computer system 24.

The GPS system 26 contains function controls that are disposed either on the single handset housing 12 or on the interactive display screen 18. The function controls of the GPS system 26 are governed by a program, and are added, deleted, or changed by a user, a manufacturer, or a service provider of the multi-function wireless communications device 10 by changing the program through the wireless interface of the wireless data system or other components of the multi-function wireless communications device 10. The function controls of the GPS system 26 comprise the finger mouse, a zoom in control, a zoom out control, a scroll up control, a scroll down control, a scroll right control, a scroll left control, a brightness adjustment control, a color adjustment control, and a vertical and horizontal hold control.

The multi-function wireless communications device 10 further comprises an AM-FM short wave radio and television receiver 28 that is completely contained within the single handset housing 12. The AM-FM short wave radio and television receiver 28 is operatively connected to the alphanumeric keypad 14, the battery interface 16, the interactive display screen 18, the wireless telephone system 20, the antenna 22, all components of the computer system 24, and the GPS system 26.

The AM-FM short wave radio and television receiver 28 comprises function controls that are governed by a program, and are disposed on the single handset housing 12 and/or the interactive display screen 18. The function controls of the AM-FM short wave radio and television receiver 28 are added, deleted, or changed by the user, a manufacturer, or a service provider of the multi-function wireless communications device 10 by changing the program through the wireless interface of the wireless data system or other components of the multi-function wireless communications device 10. The function controls of the AM-FM short wave radio and television receiver 28 comprise a station frequency channel tuning control, a volume control, a tone control, an input selection control, a station frequency channel scan control, and a station frequency channel memory recall button/control.

The multi-function wireless communications device 10 further comprises a radio frequency location system 30 that is completely contained within the single handset housing 12. The radio frequency location system 30 is supported by the computer system 24, and is operatively connected to the alphanumeric keypad 14, the battery interface 16, the interactive display screen 18, the wireless telephone system 20, the antenna 22, all components of the computer system 24, the GPS system 26, and the AM-FM short wave radio and television receiver 28.

The radio frequency location system 30 comprises a radio frequency signal strength meter that is completely contained within the single handset housing 12. The radio frequency signal strength meter of the radio frequency location system 30 determines which radio frequencies are being received and strengths of those signals.

The radio frequency location system 30 further comprises a radio frequency location database. The radio frequency location database of the radio frequency location system 30 is supported by, and is operatively connected to, the computer system 24. The radio frequency location database of the radio frequency location system 30 is completely contained within the single handset housing 12 and/or is contained within devices external to the single handset housing 12. If the radio frequency location database of the radio frequency location system 30 is external to the single handset housing 12, it is accessed by components of the multi-function wireless communications device 10, including the memory storage management system of the computer system 24, through the wireless interface of the wireless data system.

The radio frequency location database of the radio frequency location system 30 is comprised of a dynamic database of longitude and latitude coordinates of radio frequency sources, their corresponding frequencies, and their areas of coverage for wireless communications networks, infrared data networks, AM and FM radio stations, short wave radio stations, and television stations. The radio frequency location database of the radio frequency location system 30 further comprises longitude and latitude coordinates of cellular towers, longitude and latitude coordinates of AM-FM, short wave, and television towers, and longitude and latitude coordinates of radio frequency signal strength patterns. The radio frequency location database of the radio frequency location system 30 also comprises radio stations, TV channels, and wireless data frequencies. The wireless data frequencies of the radio frequency location database are sorted by station name/call letters/channels/networks, type of broadcast, e.g. news, classical music, and movie stations, name of city, zip code, longitude and latitude data of coverage area, station's frequency, geographic longitude and latitude coordinates of radio frequencies and signal strength, and type of wireless data offered.

The radio frequency location system 30 and the radio frequency location database of the radio frequency location system 30 are programmed and updated by the user, a manufacturer, or a service provider of the multi-function wireless communications device 10 through the computer system 24, other components of the multi-function wireless communications device 10, and/or the wireless interface of the wireless data system. The radio frequency location system 30 and the radio frequency location database of the radio frequency location system 30 are updated by the user using the alphanumeric keypad 14, the interactive display screen 18, the data port of the computer system 24, the memory stick socket of the computer system 24, and/or the wireless interface of the wireless data system.

The radio frequency location system 30 examines radio frequencies received from the wireless telephone system 20, the wireless data system of the computer system 24, and the AM-FM short wave and television receiver 28 so as to form information, and compares the information to the radio frequency location database of the radio frequency location system 30 in order to determine geographic longitude and latitude coordinates of the multi-function wireless communications device 10 so as to form a location determination. The location determination is accomplished through triangulation of radio frequencies and examination of round trip delay, signal strength, and other programmable location determining techniques so as to form location determination techniques. The location determination techniques are added, deleted, programmed, and updated as part of programming the radio frequency location system 30 and the radio frequency location database of the radio frequency location system 30. Longitude and latitude coordinates that are generated by the radio frequency location system 30 and the radio frequency location database of the radio frequency location system 30 are interfaced with devices, systems, and programs that are internal or external to the multi-function wireless communications device 10.

The AM-FM short wave radio and television receiver 28 and/or the GPS system 26 or the radio frequency location system 30 and the radio frequency location database of the radio frequency location system 30 interface to tune the AM-FM short ware radio and television receiver 28. The multi-function wireless communications device 10 is automatically tuned to frequencies to form pre-set radio stations, channels, and frequencies as the multi-function wireless communications device 10 is moved from one locale to another.

The AM-FM short wave radio and television receiver 28 and the radio frequency location database of the radio frequency location system 30 are calibrated together without the GPS system 26 or the radio frequency location system 30 if the multi-function wireless communications device 10 receives inputs regarding it's geographic location through the alphanumeric keypad 14, the interactive display screen 18, or the radio frequency signal strength meter of the radio frequency location system 30 about name of city and zip code in which the multi-function communications device 10 is operating.

The AM-FM short wave radio and television receiver 28, the GPS system 26 and/or the radio frequency location system 30 and the radio frequency location database of the radio frequency location system 30 interface with “on demand” wireless broadcast in order to request specific music, movies, or broadcast by name of type according to their geographic location.

The radio frequency location system 30 queries user location databases which comprise location coordinates in terms of longitude and latitude of the multi-function wireless communications device 10.

The multi-function wireless communications device 10 further comprises a user location database 34. The user location database 34 is completely contained within the single handset housing 12 and/or is contained within devices external to the single handset housing 12. If the user location database 34 is external to the single handset housing 12, it is accessed by components of the multi-function wireless communications device 10, including the memory storage management system of the computer system 24, through the wireless interface of the wireless data system.

The user location database 34 is supported by the computer system 24, and is operatively connected to the alphanumeric keypad 14, the battery interface 16, the interactive display screen 18, the wireless telephone system 20, the antenna 22, all components of the computer system 24, the GPS system 26, the AM-FM short wave radio and television receiver 28, the radio frequency location system 30, and the radio frequency location database of the radio frequency location system 30.

The user location database 34 is a dynamic database, and entries are added, deleted, programmed, and updated by the user, a manufacturer, or a service provider of the multi-function wireless communications device 10 through the computer system 24, other components of the multi-function wireless communications device 10, and/or the wireless interface of the wireless data system. The user location database 34 comprises longitude and latitude coordinates and identification information of the multi-function wireless communications device 10 and longitude and latitude coordinates and identification information of other wireless communications devices.

The user location database 34 receives longitude and latitude coordinates and identification information of the multi-function wireless communications device 10 from internal sources, such as the GPS system 26, the radio frequency location system 30 or the radio frequency location database of the radio frequency location system 30, and/or user input. The user location database 34 also receives longitude and latitude coordinates and identification information of the multi-function wireless communications device 10 and other wireless communications devices from data received from external sources, such as networks, devices, systems, programs, and process which are operatively connected to the multi-function wireless communications device 10 through the computer system 24, the wireless interface of the wireless data system, and/or other components of the multi-function wireless communications device 10.

The user location database 34 interfaces with the computer system 24 and other systems, devices, and programs that are internal and external to the multi-function wireless communications device 10 so as to from an interface. The interface is accomplished by way of uploads/downloads, the data port of the computer system 24, the memory stick socket of the computer system 24, the wireless data system of the computer system 24, the wireless telephone system 20, or through other components, systems, programs, and devices of the multi-function wireless communications device 10.

The multi-function wireless communications device 10 further comprises a navigational mapping system 36. The navigational mapping system 36 comprises a navigational mapping database. The navigational mapping system 36 is supported by the computer system 24, and is operatively connected to the alphanumeric keypad 14, the battery interface 16, the interactive display screen 18, the wireless telephone system 20, the antenna 22, all components of the computer system 24, the GPS system 26, the AM-FM short wave radio and television receiver 28, the radio frequency location system 30, the radio frequency location database of the radio frequency location system 30, and the user location database 34.

The navigational mapping database of the navigational mapping system 36 is a dynamic database which 9 is completely contained within the single handset housing 12 and/or is contained within devices external to the single handset housing 12. If the navigational mapping database of the navigational mapping system 36 is external to the single handset housing 12, it is accessed by components of the multi-function wireless communications device 10, including the memory storage management system of the computer system 24, through the wireless interface of the wireless data system.

The navigational mapping database of the navigational mapping system 36 comprises such categories of entries as street addresses, business names, business types/categories, business addresses, business telephone numbers, and street and topographical maps of cities, counties, states, and countries, and their corresponding longitude and latitude coordinates. New categories of entries are added, deleted, and updated as part of programming process of the navigational mapping system 36.

The navigational mapping system 36 overlays entries in the navigational mapping database of the navigational mapping system 36 onto street maps and topographical maps. The GPS data of the GPS system 26 and/or data from the radio frequency location system 30 and the radio frequency location database of the radio frequency location system 30, and/or data from the user location database 34 is overlaid onto the street maps and topographical maps to enable plotting of longitude and latitude of the multi-function wireless communications device 10 so as to form plotted locations. Various database entries onto the street maps and topographical maps are displayed on the interactive display screen 18 and stored in the memory system of the computer system 24. The plotted locations are then interfaced with internal and external devices, systems, and programs. The plotted locations are heard audibly through the earphone of the wireless telephone system 20.

The navigational mapping system 36 converts longitude and latitude coordinates received from the GPS system 26, the radio frequency location system 30, the radio frequency location database of the radio frequency location system 30, and/or the user location database 34 to corresponding street addresses and street/topographic map coordinates and converts street addresses and street/topographic map locations to longitude and latitude coordinates so as to form conversions. The conversions are interfaced with devices, systems, and programs which are internal or external to the multi-function wireless communications device 10.

The navigational mapping system 36 further comprises function controls that are disposed either on the single handset housing 12 or on the interactive display screen 18. The function controls of the navigational mapping system 36 comprise a zoom in control, a zoom out control, a scroll up control, a scroll down control, a scroll right control, a scroll left control, a brightness adjustment control, a color adjustment control, and a vertical and horizontal hold control. The function controls of the navigational mapping system 36 and entries in the navigational mapping database of the navigational mapping system 36 are added, deleted, or changed by the user, a manufacturer, or a service provider of the multi-function wireless communications device 10 through the wireless interface of the wireless data system or other components of the multi-function wireless communications device 10.

The multi-function wireless communications device 10 further comprises a word processing program 38. The word processing program 38 is completely contained within the single handset housing 12, is supported by the computer system 24, and is operatively connected to the alphanumeric keypad 14, the battery interface 16, the interactive display screen 18, the wireless telephone system 20, the antenna 22, all components of the computer system 24, the GPS system 26, the AM-FM short wave radio and television receiver 28, the radio frequency location system 30, the radio frequency location database of the radio frequency location system 30, the user location database 34, the navigational mapping system 36, and the navigational mapping database of the navigational mapping system 36. The word processing program 38 is added to, deleted, or changed by the user, a manufacturer, or a service provider of the multi-function wireless communications device 10 through the wireless interface of the wireless data system or other components of the multi-function wireless communications device 10.

The multi-function wireless communications device 10 further comprises a language translation program 40. The language translation program 40 is completely contained within the single handset housing 12 and comprises a language translation database. The language translation program 40 and the language translation database of the language translation program 40 are supported by the computer system 24, and are operatively connected to the alphanumeric keypad 14, the battery interface 16, the interactive display screen 18, the wireless telephone system 20, the antenna 22, all components of the computer system 24, the GPS system 26, the AM-FM short wave radio and television receiver 28, the radio frequency location system 30, the radio frequency location database of the radio frequency location system 30, the user location database 34, the navigational mapping system 36, the navigational mapping database of the navigational mapping system 36, and the word processing program 38.

The language translation database of the language translation program 40 is a dynamic database which is completely contained within the single handset housing 12 and/or is contained within devices external to the single handset housing 12. If the language translation database of the language translation program 40 is external to the single handset housing 12, it is accessed by components of the multi-function wireless communications device 10, including the memory storage management system of the computer system 24, through the wireless interface of the wireless data system.

The language translation program 40 and the language translation database of the language translation program 40 translate voice, text, and data from one language to another language. For example, from English to Spanish, from Spanish to English, from English to Italian, from Italian to English, etc, depending upon programming and database entries.

The language translation program 40 and the language translation database of the language translation program 40 are programmed by the user, a manufacturer, or a service provider of the multi-function wireless communications device 10 through the computer system 24, other components of the multi-function wireless communications device 10, or the wireless interface of the wireless data system.

The multi-function wireless communications device 10 further comprises a voice recognition program 42. The voice recognition program 42 is completely contained within the single handset housing 12, is supported by the computer system 24, and is operatively connected to the alphanumeric keypad 14, the battery interface 16, the interactive display screen 18, the wireless telephone system 20, the antenna 22, all components of the computer system 24, the GPS system 26, the AM-FM short wave radio and television receiver 28, the radio frequency location system 30, the radio frequency location database of the radio frequency location system 30, the user location database 34, the navigational mapping system 36, the navigational mapping database of the navigational mapping system 36, the word processing program 38, the language translation program 40, and the language translation database of the language translation program 40.

The voice recognition program 42 is programmed/updated by the user, a manufacturer, or a service provider of the multi-function wireless communications device 10 through the computer system 24, other components of the multi-function wireless communications device 10, or the wireless interface of the wireless data system.

The voice recognition program 42 transcribes messages so as to form transcribed messages that are stored as data in the memory system of the computer system 24 and are shared with devices and programs internal and external to the multi-function wireless communications device 10. The transcribed messages are directly downloadable into the memory system of the computer system 24 as data, are directly downloadable into the word processing program 38, are directly viewable on the interactive display screen 18, are directly faxable, are printable directly to a printer, and are directly e-mailable.

The voice recognition program 42, in conjunction with the language translation program 40 and the language translation database of the language translation program 40, translate one language into another in real 9 time so as to form a translated language that is viewed on the interactive display screen 18, is audile through the earphone of the wireless telephone system 20, and is stored in the memory system of the computer system 24.

The multi-function wireless communications device 10 further comprises a scanner 44. The scanner 44 is completely contained within the single handset housing 12, but scans through the single handset housing 12. The scanner 44 is supported by the computer system 24, and is operatively connected to the alphanumeric keypad 14, the battery interface 16, the interactive display screen 18, the wireless telephone system 20, the antenna 22, all components of the computer system 24, the GPS system 26, the AM-FM short wave radio and television receiver 28, the radio frequency location system 30, the radio frequency location database of the radio frequency location system 30, the user location database 34, the navigational mapping system 36, the navigational mapping database of the navigational mapping system 36, the word processing program 38, the language translation program 40, the language translation database of the language translation program 40, and the voice recognition program 42.

The scanner 44 comprises function controls. The function controls of the scanner 44 comprise a scan control, a preview control, and a delete control, are disposed either on the single handset housing 12 or on the interactive display screen 18, are governed by a program, and are added, deleted, or changed by the user, a manufacturer, or a service provider of the multi-function wireless communications device 10 by changing the program through the wireless interface of the wireless data system or other components of the multi-function wireless communications device 10.

The scanner 44 further comprises an optical character recognition program that is completely contained within the single handset housing 12. The optical character recognition program of the scanner 44 transcribes written text and data scanned by the scanner 44 into the computer system 24 so as to form transcribed text and data. The transcribed text and data is accessed and interfaced by devices and programs that are internal or external to the multi-function wireless communications device 10. The optical character recognition program of the scanner 44 is changed/updated by the user, a manufacturer, or a service provider of the multi-function wireless communications device 10 through the wireless interface of the wireless data system or other components of the multi-function wireless communications device 10.

The multi-function wireless communications device 10 further comprises a text voice read-up program 46. The text voice read-up program 46 is completely contained within the single handset housing 12, is supported by the computer system 24, and is operatively connected to the alphanumeric keypad 14, the battery interface 16, the interactive display screen 18, the wireless telephone system 20, the antenna 22, all components of the computer system 24, the GPS system 26, the AM-FM short wave radio and television receiver 28, the radio frequency location system 30, the radio frequency location database of the radio frequency location system 30, the user location database 34, the navigational mapping system 36, the navigational mapping database of the navigational mapping system 36, the word processing program 38, the language translation program 40, the language translation database of the language translation program 40, the voice recognition program 42, the scanner 44, and the optical character recognition program of the scanner 44.

The voice text read-up program 46 is programmed/updated by the user, a manufacturer, or a service provider of the multi-function wireless communications device 10 through the computer system 24, other components of the multi-function wireless communications device 10, or the wireless interface of the wireless data system.

The text voice read-up system 46 transcribes text and data from the memory system of the computer system 24 into transcribed audible words which are heard through the earphone of the wireless telephone system 20. The text voice read-up system 46 enables word processing documents or other data contained within the memory system of the computer system 24 to be read to the user or a caller and displayed on the interactive display screen 18 in real time.

The multi-function wireless communications device 10 further comprises a facsimile/data system 48 for facsimile and data transmissions. The facsimile/data system 48 is completely contained within the single handset housing 12, is supported by the computer system 24, and is operatively connected to the alphanumeric keypad 14, the battery interface 16, the interactive display screen 18, the wireless telephone system 20, the antenna 22, all components of the computer system 24, the GPS system 26, the AM-FM short wave radio and television receiver 28, the radio frequency location system 30, the radio frequency location database of the radio frequency location system 30, the user location database 34, the navigational mapping system 36, the navigational mapping database of the navigational mapping system 36, the word processing program 38, the language translation program 40, the language translation database of the language translation program 40, the voice recognition program 42, and the voice text read-up program 46.

The facsimile/data system 48 is programmed/updated by the user, a manufacturer, or a service provider of the multi-function wireless communications device 10 through the computer system 24, other components of the multi-function wireless communications device 10, or the wireless interface of the wireless data system.

The facsimile/data system 48 comprises function controls. The function controls of the facsimile/data system 48 are governed by a program, are disposed on the single handset housing 12 and/or the interactive display screen 18, and are added, deleted, or changed by the user, a manufacturer, or a service provider of the multi-function wireless communications device 10 by changing the program through the wireless interface of the wireless data system or other components of the multi-function wireless communications device 10. The function controls of the facsimile/data program 48 comprise a send control, a receive control, a play control, a record control, a stop control, a pause control, a rewind control, a delete control, a fast forward control, a fast forward play control, and a skip to the next message control.

The facsimile/data system 48 utilizes the computer system 24, the memory management system of the computer system 24, the word processing program 38, the language translation program 40, the language translation database of the language translation program 40, the voice recognition program 42, and the text voice read-up system 46 simultaneously to allow voice to data and data to voice to move in a free flowing fully integrated system.

The facsimile and data transmissions of the facsimile/data system 48 are previewed, edited, and signed on the interactive display screen 18, and are importable into the language translation program 40 and the language translation database of the language translation program 40 so as to allow the facsimile and data transmissions of the facsimile/data system 48 to be translated from one language to another.

The facsimile/data system 48 receives facsimiles and data so as to form received facsimile and data transmissions and sends facsimiles and data so as to form sent facsimile and data. The received facsimile and data transmissions are routed to the facsimile/data system 48 and stored in the memory system of the computer system 24, while the sent facsimile and data transmissions are routed from the facsimile/data system 48 to external devices.

The received facsimile and data transmissions that are routed to the facsimile/data system 48 and stored in the memory system of the computer system 24 are downloadable directly into a PC, a palm-held data assistant PDA, the wireless telephone system 20, a printer, as an e-mail, and the interactive display screen 18, and are importable into the word processing program 38 and the text voice read-up system 46 so as to be able to be heard audibly through the earphone of the wireless telephone system 20 so as to allow instant reviewing of the received facsimiles and data transmissions. The received facsimile and data transmissions are simultaneously displayed on the interactive display screen 18 as the received facsimile and data transmissions are played audibly through the earphone of the wireless telephone system 20, if so desired by the user.

The sent facsimile and data are created and edited by the word processing program 38, the alphanumeric keypad 14, the voice recognition program 42, downloads from the computer system 24, the interactive display screen 18, and from other components of the multi-function wireless communications device 10 so as to form created facsimile and data transmissions. The created facsimile and data transmissions are sent to external devices through the wireless data system of the computer system 24, the wireless telephone system 20, the infrared data system of the wireless data system, and other components of the multi-function wireless communications device 10.

The multi-function wireless communications device 10 further comprises a digital voice mail system 50. The digital voice mail system 50 is completely contained within the single handset housing 12, is supported by the computer system 24, and is operatively connected to the alphanumeric keypad 14, the battery interface 16, the interactive display screen 18, the wireless telephone system 20, the antenna 22, all components of the computer system 24, the GPS system 26, the AM-FM short wave radio and television receiver 28, the radio frequency location system 30, the radio frequency location database of the radio frequency location system 30, the user location database 34, the navigational mapping system 36, the navigational mapping database of the navigational mapping system 36, the word processing program 38, the language translation program 40, the language translation database of the language translation program 40, the voice recognition program 42, the voice text read-up program 46, and the facsimile/data system 48.

The digital voice mail system 50 is programmed/updated by the user, a manufacturer, or a service provider of the multi-function wireless communications device 10 through the computer system 24, other components of the multi-function wireless communications device 10, or the wireless interface of the wireless data system.

The digital voice mail system 50 comprises function controls which are disposed on the single handset housing 12 and/or the interactive display screen 18. The function controls of the digital voice mail system 50 are governed by a program, and are added, deleted, or changed by the user, a manufacturer, or a service provider of the multi-function wireless communications device 10 by changing the program through the wireless interface of the wireless data system or other components of the multi-function wireless communications device 10. The function controls of the digital voice mail system 50 comprise a send control, a receive control, a play control, a record control, a stop control, a pause control, a delete control, a rewind control, a fast forward control, a fast forward play control, and a skip to the next message control.

The digital voice mail system 50 further comprises a digital answering machine that is completely contained within the single handset housing 12.

The digital voice mail system 50 digitally records voice messages so as to form recorded voice messages. The recorded voice messages are stored in the memory system of the computer system 24 so as to form stored recordings. The stored recordings are transcribed into text through the voice recognition program 42 and then stored as transcribed recordings in the memory system of the computer system 24.

The voice recognition program 42 transcribes voice mail of the digital voice mail system 50 upon retrieval from the digital voice mail system 50 or from external voice mail systems into data. The data is stored in the memory system of the computer system 24, is directly faxable, is directly word processable, is directly printable to a printer, is directly translatable, and is directly e-mailable. The data is directly audible through the earphone of the wireless telephone system 20 with support of the text voice read-up system 46, and is simultaneously displayed in text form on the interactive display screen 18, if desired by the user.

The digital voice mail system 50 is an alternative to the external voice mail systems as a cost savings and convenience benefit either when the primary carrier of the wireless telephone system 20 does not offer external voice mail or when roaming.

The transcribed recordings of the digital voice mail system 50 are previewed on the interactive display screen 18, are edited by using the alphanumeric keypad 14, the voice recognition program 42, and the interactive display screen 18, are played back audibly through the earphone of the wireless telephone system 20 while being simultaneously displayed in text form on the interactive display screen 18, if so desired by the user, and are viewed in real time on the interactive display screen 18 in order to allow the user to read the transcribed recordings of the digital voice mail system 50 as they are being deposited by a caller into the digital voice mail system 50 so as to eliminate the user from having to retrieve the transcribed recordings of the digital voice mail system 50.

The digital voice mail system 50 further comprises a dynamic geographically based voice mail database. The geographically based voice mail database of the digital voice mail system 50 is completely contained within the single handset housing 12 and/or is contained within devices external to the single handset housing 12. If the geographically based voice mail database of the digital voice mail system 50 is external to the single handset housing 12, it is accessed by components of the multi-function wireless communications device 10, including the memory storage management system of the computer system 24, through the wireless interface of the wireless data system.

The geographically based voice mail database of the digital voice mail system 50 is programmed/updated by the user, a manufacturer, or a service provider of the multi-function wireless communications device 10 through the computer system 24, the wireless interface of the wireless data system, the voice recognition program 42, or other components of the multi-function wireless communications device 10.

The geographically based voice mail database of the digital voice mail system 50 comprises geographic availability of external voice mail systems, names of service providers, names of cities, zip codes, longitude and latitude data relating to their area of service coverage, their radio frequencies and type of voice mail systems, and information on how to interface with the external voice mail systems.

The geographically based voice mail database of the digital voice mail system 50 is useable without the GPS system 26, the radio frequency location system 30, and the radio frequency location database and/or the user location database 34, if the user inputs by voice, the interactive display screen 18, or the alphanumeric keypad 14, the name of city or zip code the user is located in.

The digital voice mail system 50 interrogates both the geographically based voice mail database of the digital voice mail system 50 and name of city, zip code, and the navigational mapping system 36, the navigational mapping database of the navigational mapping system 36, the GPS system 26 and/or radio frequency data, or the user location database 34 to determine when the external voice mail system of the service provider is not available due to roaming, and if not, the digital voice mail system 50 answers telephone calls.

The multi-function wireless communications device 10 further comprises a recording system 52. The recording system 52 is completely contained within the single handset housing 12, is supported by the computer system 24, and is operatively connected to the alphanumeric keypad 14, the battery interface 16, the interactive display screen 18, the wireless telephone system 20, the antenna 22, all components of the computer system 24, the GPS system 26, the AM-FM short wave radio and television receiver 28, the radio frequency location system 30, the radio frequency location database of the radio frequency location system 30, the user location database 34, the navigational mapping system 36, the navigational mapping database of the navigational mapping system 36, the word processing program 38, the language translation program 40, the language translation database of the language translation program 40, the voice recognition program 42, the voice text read-up program 46, the facsimile/data system 48, the digital voice mail system 50, and the geographically based voice mail database of the digital voice mail system 50.

The recording system 52 is programmed by the user through the computer system 24 or other components of the multi-function wireless communications device 10 so long as programming complies with voice recording laws of each locale in which the wireless telephone system 20 is operable. The recording system 52 is programmed/updated by the user, a manufacturer, or a service provider of the multi-function wireless communications device 10 using the wireless interface of the wireless data system or other components of the multi-function wireless communications device 10 so long as the programming/updating complies with the voice recording laws of each locale in which the wireless telephone system 20 is operating.

The recording system 52 comprises function controls that are governed by a program, are disposed on the single handset housing 12 and/or the interactive display screen 18, and are added, deleted, or changed by the user, a manufacturer, or a service provider of the multi-function wireless communications device 10 by changing the program through the wireless interface of the wireless data system or other components of the multi-function wireless communications device 10. The function controls of the recording system 52 comprise a play control, a record control, a stop control, a pause control, a rewind control, a delete control, a fast forward control, a fast forward play control, and a skip to next message control.

The recording system 52 further comprises a dynamic recording system database of voice recording laws of each locale in which the wireless telephone system 20 is operational and longitude and latitude and/or street and topographical map coordinates corresponding to the voice recordings laws. The recording system database of the recording system 52 is completely contained within the single handset housing 12 and/or is contained within devices external to the single handset housing 12. If the recording system database of the recording system 52 is external to the single handset housing 12, it is accessed by components of the multi-function wireless communications device 10, including the memory storage management system of the computer system 24, through the wireless interface of the wireless data system.

The recording system database of the recording system 52 is programmed/updated by the user, a manufacturer, or a service provider of the multi-function wireless communications device 10 using the wireless interface of the wireless data system or other components of the multi-function wireless communications device 10 so long as the programming/updating complies with the voice recording laws of each locale in which the wireless telephone system 20 is operating.

The recording system 52 interrogates both the recording system database of the recording system 52, the navigational mapping system 36, the navigational mapping database of the navigational mapping system 36, the GPS system 26 and/or the radio frequency location system 30, the radio frequency database of the radio frequency location system 30, and/or the user location database 34 to determine if the voice recording laws of the locale in which the wireless telephone system 20 is operating allow recording of a telephone conversation, if not it prevents recording, or if the voice recording laws of the locale allows recording of the telephone conversation with notice to a caller.

The recording system 52 interrogates both the recording system database of the recording system 52, the navigational mapping system 36, the navigational database of the navigational mapping system 36, the GPS system 26 and/or the radio frequency location system 30, and the radio frequency database of the of the radio frequency location system 30 and/or the user location database 34 to determine if the voice recording laws of the locale require a recording notice if the voice recording laws of the locale allow the recording of the telephone conversation, and does not play the recording notice if the voice recording laws of the locale do not require such a recording notice, but does play the audible recorded notice before recording if the voice recording laws of the locale require the recording notice. The audible recording notice is manually turned on and off by the user so long as it does not conflict with the voice recording laws of that locale. The recording system 52 provides audible beep sounds during recording if the voice recording laws of the locale require such a recording notice, and which are manually turned on and off by the user so long as it does not conflict with the voice recording laws of that locale.

The recording system 52 records a telephone conversation without a recording notice so as to form a recorded telephone conversation if the voice recording laws of the locale allow recording of the telephone conversation without notice. The voice recognition program 42 transcribes the recorded telephone conversation to data that is stored in the memory system of the computer system 24, is downloadable directly to facsimile, is downloadable directly to a PC, is downloadable directly to a printer, is downloadable directly as an e-mail, or to other devices and/or programs internal or external to the multi-function wireless communications device 10.

The recorded telephone conversation is played back through the earphone of the wireless telephone system 20 so as to allow the user and a caller to hear the recorded telephone conversation, so as to allow the user and the caller to hear messages, and so as to allow the user and the caller to hear facsimiles.

The voice recognition program 42 transcribes the telephone conversation to data so as to form a transcribed telephone conversation that is entered into the memory system of the computer system 24 and the word processing program 38, and is displayed on the interactive display screen 18 in real time so as to allow a deaf user to read the transcribed telephone conversation and to answer back with the deaf user's voice or other input sources. In this application, the use of the GPS system 26, the radio frequency location system 30, the radio frequency location database of the radio frequency location system 30, the user location database 34, or the recording system database of the recording system 52 are not required since the telephone conversation is not actually being recorded but is just being displayed on the interactive display screen 18.

The word processing program 38, the language translation program 40, the language translation database of the language translation program 40, the text voice read-up program 46, and the voice recognition program 42 operate with the recording system 52 in order to translate the recorded conversation from one language to another.

The recording system 52 comprises a voice memo recorder. The voice memo recorder of the recording system 52 records memos so as to form recorded memos that are audible through the earphone of the wireless telephone system 20. The voice recognition program 42 transcribes the recorded memos so as to form data that is stored in the memory system of the computer system 24. The voice recognition program 42 transcribes the recorded memos so as to form created text that is processed in the word processing program 38, is downloadable directly to facsimile, a PC, a printer, and as an e-mail, or to other devices and programs internal or external to the multi-function wireless communications device 10, and which is previewable on the interactive display screen 18.

The created text is edited using the word processing program 38, the alphanumeric keypad 14, the voice recognition program 42, and the interactive display screen 18, and is simultaneously previewed on the interactive display screen 18, if so desired by the user, while the recorded memos are audible through the earphone of the wireless telephone system 20.

The multi-function wireless communications device 10 further comprises a download system 54. The download system 54 is completely contained within the single handset housing 12, and is supported by the computer system 24. The download system 54 is operatively connected to the alphanumeric keypad 14, the battery interface 18, the interactive display screen 18, the wireless telephone system 20, the antenna 22, all components of the computer system 24, the GPS system 26, the AM-FM short wave radio and television receiver 28, the radio frequency location system 30, the radio frequency location database of the radio frequency location system 30, the user location database 34, the navigational mapping system 36, the navigational mapping database of the navigational mapping system 36, the word processing program 38, the language translation program 40, the language translation database of the language translation program 40, the voice recognition program 42, the voice text read-up program 46, the facsimile/data system 48, the digital voice mail system 50, the geographically based voice mail database of the digital voice mail system 50, and the recording system 52.

The download system 54 is programmed by the user, a manufacturer, or a service provider of the multi-function wireless communications device 10 through the alphanumeric keypad 14, the interactive display screen 18, the memory stick socket of the computer system 24, the data port of the computer system 24, the wireless data system of the computer system 24, the wireless telephone system 20, the computer system 24, or the voice recognition program 42.

The download system 54 uploads and downloads data to and from the computer system 24 to and from devices that are internal and external to and from the multi-function wireless communications device 10. The download system 54 uploads and downloads data directly to and from the memory stick socket of the computer system 24 for storing on the removable memory stick, directly to and from a facsimile machine, directly to and from a PC, directly to and from a palm held device PDA, directly to and from the wireless data system of the computer system 24, directly to and from the wireless telephone system 20, and directly to and from a printer. The uploads and downloads are by way of the computer system 24, hardware, software, firmware, wireless, the wireless telephone system 20, the data port of the computer system 24, and the memory stick socket of the computer system 24, and are audible through the earphone of the wireless telephone system 20 for the user to hear and a caller to hear.

The download system 54 enables a seamless flow of data from hardware to hardware, from hardware to software, and from software to software, and a seamless flow of transition from written text, which is scanned by the scanner 44 and transcribed to text by the character recognition program of the scanner 44, to audible words via the text voice read-up program 46.

The download system 54 enables systems and programs of the multi-function wireless communications device 10 to be operatively connected in any combination of its devices, systems, programs, and databases. The multi-function wireless communications device 10 enables a seamless flow of language transition from one language to another in real time, from voice to voice, from voice to text, from text to voice, or from text to text, and a seamless flow from systems to databases to programs.

The multi-function wireless communications device 10 further comprises a roaming system 56. The roaming system 54 is completely contained within the single handset housing 12, and is supported by the computer system 24. The roaming system 56 is operatively connected to the alphanumeric keypad 14, the battery interface 16, the interactive display screen 18, the wireless telephone system 20, the antenna 22, all components of the computer system 24, the GPS system 26, the AM-FM short wave radio and television receiver 28, the radio frequency location system 30, the radio frequency location database of the radio frequency location system 30, the user location database 34, the navigational mapping system 36, the navigational mapping database of the navigational mapping system 36, the word processing program 38, the language translation program 40, the language translation database of the language translation program 40, the voice recognition program 42, the voice text read-up program 46, the facsimile/data system 48, the digital voice mail system 50, the geographically based voice mail database of the digital voice mail system 50, the recording system 52, and the download system 54.

The roaming system 56 is programmed by the user, a manufacturer, or a service provider of the multi-function wireless communications device 10 through the computer system 24, the wireless interface of the wireless data system, or other components of the multi-function wireless communications device 10.

The roaming system 56 comprises a dynamic roaming system database of analog, digital code division multiple access CDMA, TDMA, GSM, second generation networks, third generation networks, and other types of cellular, personal communications systems which provide service to a subscriber station capable of operating in a plurality of geographic regions, and their corresponding longitude and latitude coordinates or street/topographical map areas of coverage. The service providers are matched with their cities and zip codes of coverage, corresponding radio frequencies, price schedules, and corresponding time of day, and longitude and latitude and/or street/topographic map coordinates for region of coverage for each particular service provider.

The roaming system database of the roaming system 56 is completely contained within the single handset housing 12 and/or is contained within devices external to the single handset housing 12. If the roaming system database of the roaming system 56 is external to the single handset housing 12, it is accessed by components of the multi-function wireless communications device 10, including the memory storage management system of the computer system 24, through the wireless interface of the wireless data system.

The roaming system database of the roaming system 56 is programmed by the user, a manufacturer, or a service provider of the multi-function wireless communications device 10 with the alphanumeric keypad 14, the interactive display screen 18, the data port of the computer system 24, the memory stick socket of the computer system 24, the wireless interface of the wireless data system, or other components of the multi-function wireless communications device 10.

The roaming system 56 is queried by the voice recognition program 42, and operates without the GPS system 26 and/or the radio frequency location system 30 and/or the radio frequency location database of the radio frequency location system 30 and/or the user location database 34 by the user inputting through the voice recognition program 42, the interactive display screen 18, the navigational mapping system 36, the navigational mapping database of the navigational mapping system 36, or the alphanumeric keypad 14, a geographic location by city name, cross street or zip code.

The roaming system database of the roaming system 56 comprises a selection process to determine an optimal service provider. The selection process of the roaming system database takes into consideration name of city, zip code, and longitude and latitude coordinates or street/topographical map coordinates of the multi-function wireless communications device 10 for a geographic region at the time a call is placed or received. The selection process of the roaming system database also considers longitude and latitude coordinates and/or street/topographical map coordinates of service providers that are available in that geographic region, signal strength and areas of service coverage of available service providers, time of day and corresponding price schedule of the service providers, cost of long distance fees charged by the service providers, if any, and cost of daily access fees charged by the service providers, if any.

The roaming system 56 interrogates the roaming system database of the roaming system 56, the selection process of the roaming system database, the navigational mapping system 36 and the navigational mapping database of the navigational mapping system 36, and/or the GPS system 26, and/or the radio frequency location system 30 and the radio frequency location database of the of the radio frequency location system 30, and/or the user location database 34 to determine lowest roaming rates and long distance rates that are best available when traveling outside the home calling area of the wireless telephone system 20 so as to form the best available roaming rates.

The roaming system 56 interrogates the roaming system database of the roaming system 56, the selection process of the roaming system database, the navigational mapping system 36 and the navigational mapping database of the navigational mapping system 36, and/or the GPS system 26, and/or the radio frequency location system 30 and the radio frequency location database of the radio frequency location system 30, and/or the user location database 34 to adjust the radio frequency of the wireless telephone system 20 to match the best available roaming rates.

The roaming system 56 interrogates the roaming system database of the roaming system 56, the selection process of the roaming system database, the navigational mapping system 36 and the navigational mapping database, the GPS system 26, and/or the radio frequency location system 30 and the radio frequency location database of the radio frequency location system 30, and/or the user location database 34 to adjust the radio frequency of the wireless telephone system 20 to match available phone service so as to avoid a no service problem.

The multi-function wireless communications device 10 further comprises a call routing system 58. The call routing system 58 is completely contained within the single handset housing 12, and is supported by the computer system 24. The call routing system 58 is operatively connected to the alphanumeric keypad 14, the battery interface 16, the interactive display screen 18, the wireless telephone system 20, the antenna 22, all components of the computer system 24, the GPS system 26, the AM-FM short wave radio and television receiver 28, the radio frequency location system 30, the radio frequency location database of the radio frequency location system 30, the user location database 34, the navigational mapping system 36, the navigational mapping database of the navigational mapping system 36, the word processing program 38, the language translation program 40, the language translation database of the language translation program 40, the voice recognition program 42, the voice text read-up program 46, the facsimile/data system 48, the digital voice mail system 50, the geographically based voice mail database of the digital voice mail system 50, the recording system 52, the download system 54, and the roaming system 56.

The call routing system 58 is programmed by the user, a manufacturer, or a service provider of the multi-function wireless communications device 10 through the computer system 24, the wireless interface of the wireless data system, or other components of the multi-function wireless communications device 10.

The call routing system 58 identifies voice calls and transfers voice calls to be answered by the digital voice mail system 50 after a selected number of rings, if selected, or if the user is on a call. The call routing system 58 identifies facsimile/data calls and transfers calls to the facsimile/data system 48 if it is a facsimile or a data transmission.

The multi-function wireless communications device 10 further comprises a dialing phonebook system 60. The dialing phonebook system 60 is completely contained within the single handset housing 12, and is supported by the computer system 24. The dialing phonebook system 60 is operatively connected to the alphanumeric keypad 14, the battery interface 16, the interactive display screen 18, the wireless telephone system 20, the antenna 22, all components of the computer system 24, the GPS system 26, the AM-FM short wave radio and television receiver 28, the radio frequency location system 30, the radio frequency location database of the radio frequency location system 30, the navigational mapping system 36, the navigational mapping database of the navigational mapping system 36, the word processing program 38, the language translation program 40, the language translation database of the language translation program 40, the voice recognition program 42, the voice text read-up program 46, the facsimile/data system 48, the digital voice mail system 50, the geographically based voice mail database of the digital voice mail system 50, the recording system 52, the download system 54, and the call routing system 58.

The dialing phonebook system 60 is programmed by the user, a manufacturer, or a service provider of the multi-function wireless communications device 10, through the computer system 24, other components of the multi-function wireless communications device 10, and/or the wireless interface of the wireless data system

The dialing phonebook system 60 comprises function controls which are governed by a program, and are added, deleted, or changed by the user, a manufacturer, or a service provider of the multi-function wireless communications device 10 by changing the program through the wireless interface of the wireless data system or other components of the multi-function wireless communications device 10 in order to correspond with geographic changes, telephone number changes, and software changes.

The function controls of the dialing phonebook system 60 comprise a select entry control, a dial entry control, an add entry control, a delete entry control, the finger mouse, a zoom in control, a zoom out control, a scroll up control, a scroll down control, a scroll right control, a scroll left control, a brightness adjustment control, a color adjustment control, and a vertical and horizontal hold control.

The dialing phonebook system 60 further comprises a geographically based phonebook database. The geographically based phonebook database of the dialing phonebook system 60 is completely contained within the single handset housing 12 and/or is contained within devices external to the single handset housing 12. If the geographically based phonebook database of the dialing phonebook system 60 is external to the single handset housing 12, it is accessed by components of the multi-function wireless communications device 10, including the memory storage management system of the computer system 24, through the wireless interface of the wireless data system or other components of the multi-function wireless communications device 10.

The geographically based phonebook database of the dialing phonebook system 60 comprises categories of entries, such as business and personal names, categories/type of specific business services, telephone number, facsimile number, street address, city, state, zip code, and each entries corresponding longitude and latitude or street/topographical map coordinates. The categories of entries are added, deleted, updated, or programmed as part of the geographically based phonebook database of the dialing phonebook system 60.

The geographically based phonebook database of the dialing phonebook system 60 is updated by the user, a manufacturer, or a service provider of the multi-function wireless communications device 10 through components of the multi-function wireless communications device 10 or with the wireless interface of the wireless data system, and is queried through the voice recognition program 42, the alphanumeric keypad 14, or the interactive display screen 18.

The dialing phonebook system 60 is operatively connected to the GPS system 26 and/or the radio frequency location system 30 and the radio frequency location database of the radio frequency location system 30, 6 and/or the user location database 34, and/or the navigational mapping system 36 and the navigational mapping database of the navigational mapping system 36. The dialing system phonebook 60 is queried in order to display locations of selected entries by business and personal names, categories/type of specific business services, telephone number, facsimile number, street address, city, state, zip code, and/or each entry's corresponding longitude and latitude or street/topographical coordinates, and the location of the multi-function wireless communications device 10 on the street/topographical map.

The dialing phonebook system 60 also operates without the navigational mapping system 36 and the navigational mapping database of the navigational mapping system 36, and without the GPS system 26, the radio frequency location system 30 and the radio frequency location database of the radio frequency location system 30, or the user location database 34, if the user inputs name, name of the city, or, zip code through one components, programs, or systems of the multi-function wireless communications device 10.

The dialing phonebook system 60 interrogates the geographically based phonebook database of the dialing phonebook system 60 and name of city, zip code, the navigational mapping system 36 and the navigational mapping database of the navigational mapping system 36, and/or GPS system 26, the radio frequency location system 30 and the radio frequency location database of the radio frequency location system 30, or the user location database 34 to connect the multi-function wireless communications device 10 to a specific entity(ies) which is/are geographically closest. A selected number of additional geographically close entries are also displayed on the interactive display screen 18.

The dialing phonebook system 60 further comprises a customer service button that is disposed on the single handset housing 12 and/or the interactive display screen 18. The customer service button of the dialing phonebook system 60 connects the wireless telephone system 20 to a customer service location based on geographic coordinates of the multi-function wireless communications device 10 so as to form a customer service destination. The customer service destination is programmed/updated as part of the dialing phonebook system 60 and the geographically based phonebook database of the dialing phonebook system 60.

The dialing phonebook system 60 further comprises an external voicemail button/control that is disposed on the single handset housing 12 and/or the interactive display screen 18, and connects a roaming user to a correct voice mail box/number based on geographic location of the multi-function wireless communications device 10 so as to form a voice mail destination. The voice mail destination is programmed/updated as part of the dialing phonebook system 60 and the geographically based phonebook database of the dialing phonebook system 60.

The dialing phonebook system 60 further comprises an Internet access button/control that is disposed on the single handset housing 12 and/or the interactive display screen 18, and connects a roaming user to a local Internet access number or preferred Internet access number based on geographic location of the multi-function wireless communications device 10 so as to form a roaming destination. The Internet access button of the dialing phonebook system 60 is used in order to save on long distance charges or roaming fees that are associated with connecting the roaming user to his/her home Internet access number. The roaming destination is programmed/updated as part of the dialing phonebook system 60 and the geographically based phonebook database of the dialing phonebook system 60.

The dialing phonebook system 60 further comprises a programmable dialing system that dials a designated telephone number based on geographic longitude/latitude and/or street/topographical map coordinates of the multi-function wireless communications device 10 so as to form a designated destination. The designated destination is programmed/updated as part of the dialing phonebook system 60 and the geographically based phonebook database of the dialing phonebook system 60. The geographic longitude/latitude and/or street/topographical map coordinates of the multi-function wireless communications device 10 are determined by the GPS system 26, the radio frequency location system 30 and the radio frequency location database of the radio frequency location system 30, the user location database 34, or the navigational mapping system 36 and the navigational mapping database of the navigational mapping system 36, and/or user input. The dialing phonebook system 60 operates independently of the navigational mapping system 36 and the navigational mapping database of the navigational mapping system 36 or works in conjunction with the navigational mapping system 36 and the navigational mapping database of the navigational mapping system 36.

The dialing phonebook system 60 is accessed by the word processing program 38, the language translation program 40, the voice recognition program 42, the voice text read-up program 46, a menu on the interactive display screen 18, the alphanumeric keypad 14, or a users choice entered on the interactive display screen 18.

The multi-function wireless communications device 10 further comprises a car stereo and onboard computer interface system 62 that is completely contained within the single handset 12 housing. The car stereo and onboard computer interface system 62 interfaces with a car stereo receiver and a car onboard computer system, if any, and at least one car stereo speaker that is operatively connected to the car stereo receiver or the car onboard computer.

The car stereo and onboard computer interface system 62 is supported by the processor of the computer system 24, the hard drive of the computer system 24, and the rest of the computer system 24. The car stereo and onboard computer interface system 62 is operatively connected to the alphanumeric keypad 14, the battery interface 16, the interactive display screen 18, the wireless telephone system 20, the antenna 22, all components of the computer system 24, the GPS system 26, the AM-FM short wave radio and television receiver 28, the radio frequency location system 30 and the radio frequency location database of the radio frequency location system 30, the user location database 34, the navigational mapping system 36 and the navigational mapping database of the navigational mapping system 36, the word processing program 38, the language translation program 40 and the language translation database of the language translation program 40, the voice recognition program 42, the voice text read-up program 46, the facsimile/data system 48, the digital voice mail system 50, the geographically based voice mail database of the digital voice mail system 50, the recording system 52, the download system 54, the call routing system 58, and the geographically based phonebook database of the dialing phonebook system 60.

The car stereo and onboard computer interface system 62 comprises a cradle that is operatively connected to components of the multi-function wireless communications device 10, and integrates with the car stereo receiver and/or the car onboard computer so as to allow the multi-function wireless communications device 10 to act in a hands free mode through the car stereo receiver or the car onboard computer and allow a caller's voice to be heard through the at least one car speaker when the single handset housing 12 is in the cradle.

The cradle of car stereo and onboard computer interface system 62 is integrated with the cars stereo system and/or the car onboard computer system, if any, to allow an interface for uploads and downloads of data, and electrically communicates with the battery interface 16 for recharging the battery.

The multi-function wireless communications device 10 interfaces with the car stereo system and/or the car onboard computer system for data uploads and downloads through the wireless interface of the wireless data system. The multi-function wireless communications device 10 interfaces with the car stereo receiver and/or the car onboard computer through the wireless interface of the wireless data system so as to allow a hands free method of speaking to a caller through the car stereo system and allow a caller's voice to be heard through at least one car speaker.

The car stereo and onboard computer interface system 62 further comprises a data cable port that is operatively connected to the multi-function wireless communications device 10 and to all its components and systems. The data cable port of the car stereo and onboard computer interface system 62, when operatively connected with a data cable to the car stereo and/or the car onboard computer system, integrates with the multi-function wireless communications device 10 to act in a hands free method through the car stereo and allow a caller's voice to be played through the at least one car speaker. The data cable port of the car stereo and onboard computer interface system 62 electrically communicates with the battery interface 16 for recharging the battery.

The data cable port of the car stereo and onboard computer interface system 62 is completely contained within the single handset housing 12, is accessed through the single handset housing 12, and connects to devices external to the multi-function wireless communications device 10.

The cradle of the car stereo and onboard computer interface system 62, the wireless interface of the wireless data system, and/or the data cable port of the car stereo and onboard computer interface system 62 downloads data to and from the hard drive of the computer system 24 so as to form first uploaded/downloaded data. The first uploaded/downloaded data is sent to and from the car stereo receiver or the car onboard computer system so as to form second uploaded/downloaded data. The second uploaded/downloaded data is then storable in, and can be accessed by, the car stereo receiver, the car onboard computer system, and/or the multi-function wireless communications device 10.

The AM-FM short wave radio and television receiver 28, the navigational mapping system 36 and the navigational mapping database of the navigational mapping system 36, the GPS system 26, and/or the radio frequency location system 30 and the radio frequency location database of the radio frequency location system 30, the user location database 34, the computer system 24, and all other systems and programs are accessible by the car stereo receiver or the car onboard computer through an interface by way of the cradle of the car stereo and onboard computer interface system 62, the wireless interface of the wireless data system, and/or the data cable port of the car stereo and onboard computer interface system 62 when operatively connected with a data cable.

The car stereo and onboard computer interface system 62 lowers volume of the car stereo receiver when the wireless telephone system 20 rings, via the wireless interface of the wireless data system, the data cable port of the car stereo and onboard computer interface system 62, or the cradle of the car stereo and onboard computer interface system 62.

The multi-function wireless communications device 10 further comprises a digital still camera 64 that is completely contained within the single handset housing 12. The digital still camera 64 records digitized photographs through the single handset housing 12, and is operatively connected to the alphanumeric keypad 14, the battery interface 16, the interactive display screen 18, the wireless telephone system 20, the antenna 22, all components of the computer system 24, the GPS system 26, the AM-FM short wave radio and television receiver 28, the radio frequency location system 30 and the radio frequency database of the radio frequency location system 30, the user location database 34, the navigational mapping system 36 and the navigational mapping database of navigational mapping system 36, the word processing program 38, the language translation program 40 and the language translation database of the language translation program 40, the voice recognition program 42, the voice text read-up program 46, the facsimile/data system 48, the digital voice mail system 50, the geographically based voice mail database of the digital voice mail system 50, the recording system 52, the download system 54, the call routing system 58, the geographically based phonebook database of the dialing phonebook system 60, and the car stereo and onboard computer interface system 62.

The digitized photographs of the digital still camera 64 are displayed on the interactive display screen 18 and stored in the memory system of the computer system 24. The digitized photographs of the digital still camera 64 are downloadable by other devices internal and external to the multi-function wireless communications device 10, through the memory system of the computer system 24.

The digital still camera 64 contains function controls that are disposed either on the single handset housing 12 or on the interactive display screen 18. The function controls of the digital still camera 64 are governed by a program, and are added, deleted, or changed by the user, a manufacturer, or a service provider of the multi-function wireless communications device 10 by changing the program through the wireless interface of the wireless data system or other components of the multi-function wireless communications device 10.

The function controls of the digital still camera 64 comprise a capture (shutter) control, a review control, a preference control, a flash control, a delete control, a zoom in control, a zoom out control, a scroll up control, a scroll down control, a scroll right control, a scroll left control, and a “send to” control.

The multi-function wireless communications device 10 further comprises a digital video camera 66 that is completely contained within the single handset housing 12. The digital video camera 66 records digitized recordings through the single handset housing 12, is operatively connected to the scanner 44 so as to be an input device therefore, is supported by the computer system 24, is operatively connected to the alphanumeric keypad 14, the battery interface 16, the interactive display screen 18, the wireless telephone system 20, the antenna 22, all components of the computer system 24, the GPS system 26, the AM-FM short wave radio and television receiver 28, the radio frequency location system 30 and the radio frequency location database of the radio frequency location system 30, the user location database 34, the navigational mapping system 36 and the navigational mapping database of the navigational mapping system 36, the word processing program 38, the language translation program 40 and the language translation database of the language translation program 40, the voice recognition program 42, the voice text read-up program 46, the facsimile/data system 48, the digital voice mail system 50, the geographically based voice mail database of the digital voice mail system 50, the recording system 52, the download system 54, the call routing system 58, the geographically based phonebook database of the dialing phonebook system 60, the car stereo and onboard computer interface system 62, and the digital still camera 64.

The digitized recordings of the digital video camera 66 are displayed on the interactive display screen 18 and stored in the memory system of the computer system 24. The digitized recordings are downloadable by other devices internal and external to the multi-function wireless communications device 10, through the memory system of the computer system 24.

The digital video camera 66 contains function controls that are disposed either on the single handset housing 12 or on the interactive display screen 18, are governed by a program, and are added, deleted, or changed by the user, a manufacturer, or a service provider of the multi-function wireless communications device 10 by changing the program through the wireless interface of the wireless data system or other components of the multi-function wireless communications device 10.

The function controls of the digital video camera 66 comprise a capture (record) control, a stop control, a review control, a play control, a pause control, a rewind control, a fast forward control, a fast forward play control, a skip to next screen control, a preferences control, a lighting control, a delete control, a zoom in control, a zoom out control, a volume control, and a “send to” control.

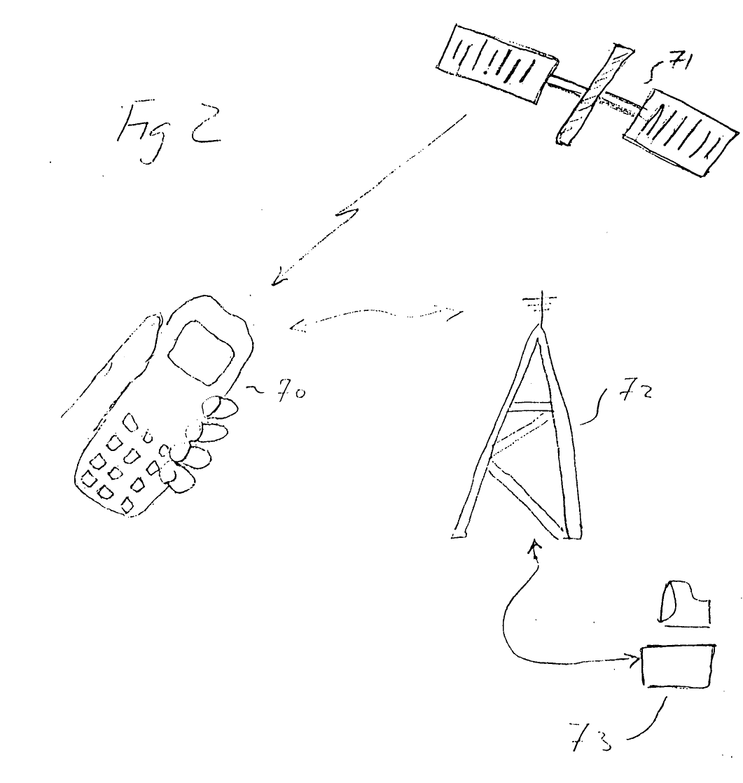

FIG. 2 is a functional diagram of the invention.

In this embodiment of the invention, the user, via cellular phone 70, is able to communicate with cellular tower 72 which communicates with computer 73. The data base discussed above is contained within computer 73.

The location of cellular phone 70, and hence the operator, is established using satellites 71. This information is communicated to computer 73 which withdraws the sought-after data based upon the location of cellular phone 70 and the category sought by the user.

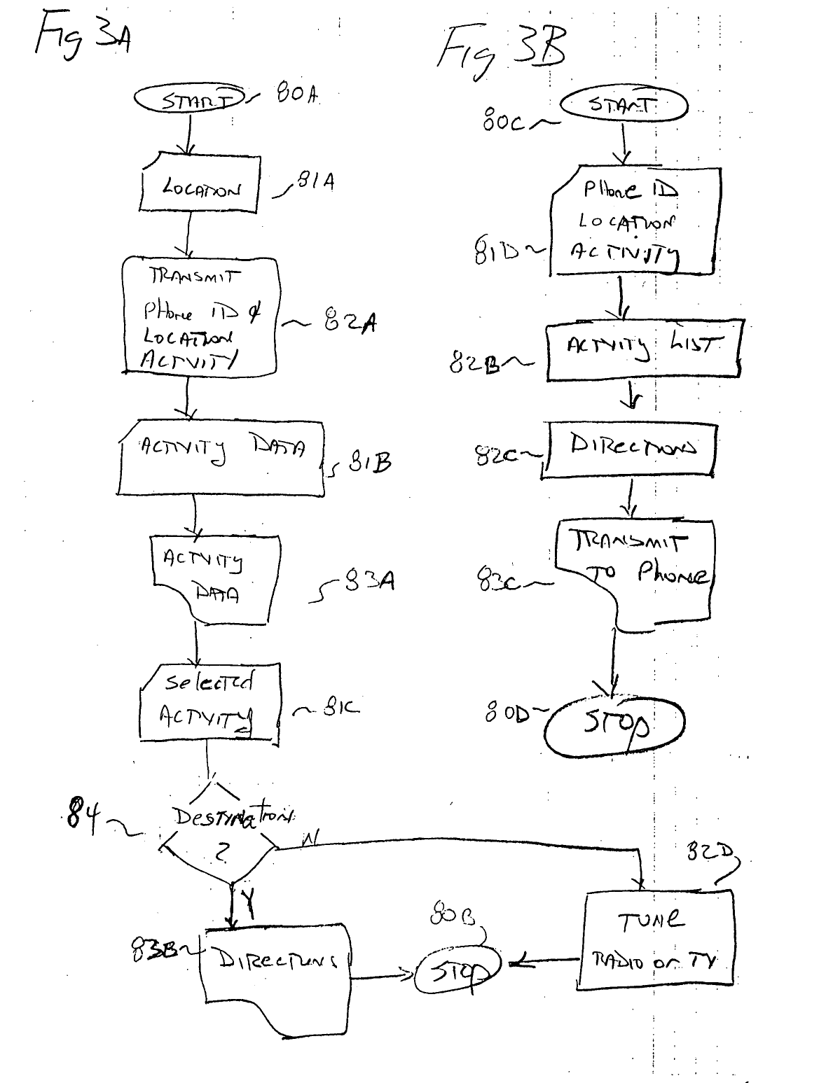

FIG. 3A is a flow chart of the operation of the cellular phone of the preferred embodiment.

At the start of operation 80A, the location of the cell phone is established 81A using a variety of techniques well known to those of ordinary skill in the art. These include, but are not limited to, satellite systems and ground based triangulation.

The location, together with the cellular phones identification, and the activity that is sought is communicated to the computer 82A. In response to this transmission, the cellular phone receive the activity data sought (i.e. “Where is a good Italian Restaurant?” or “How do I get to the art museum?”) 81B which is communicated 83A to the user.

Often, there is a second selection (i.e. picking one of many Italian Restaurants) 81 C. If the proper response is the identification of a destination, 84, then directions are communicated to the user 83B and the operation stops 80B.

If though, the activity (from 81C) is not a destination 84, then the radio or television within the cellular phone is tuned to the desired channel 82D and the program stops 80B. In this case, the user is able to visit another town and find the desired channels within that town (in the case of radio, perhaps a classical station; for the television, the local CBS station). In this situation also, the local program schedule is easily obtained so that a favorite program is not missed.

FIG. 3B is a flow chart of the operation of the computer containing the data base.

Once start occurs 80C, the phone identification, location and activity are collected 81D. The proper activity list is pulled 82B from memory and the directions (if needed) are also obtained from memory 82C.

This information is then transmitted to the cellular phone 83C and the program stops 80D.

It will be understood that each of the elements described above, or two or more together, may also find a useful application in other types of constructions differing from the types described above.

While the invention has been illustrated and described as embodied in a multi-function wireless communications device, however, it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

1. A communication system comprising:
a) a communication network communicating messages between phones;
b) a data storage means having area specific data being specific to a locale of said communication network stored therein; and,
c) a mobile phone having,
1) means for identifying a location of said mobile phone, and,
2) means for selectively withdrawing said data from the data storage means via said communication network.

2. The communication system according to claim 1, wherein said mobile phone further includes:
a) means for matching, based upon said area specific data, an operator generated input to a desired area specific data value; and,
b) means for communicating said area specific data value a remote location via said communication network.

3. The communication system according to claim 1, wherein said mobile phone further includes means for communicating a location of said mobile phone to a remote computer.

4. The communication system according to claim 1, wherein said mobile phone further includes means for communicating with a remote computer secured to a vehicle.

5. The communication system according to claim 3, wherein said mobile phone further includes means for downloading contents of a memory in said mobile phone into said remote computer.

6. The communication system according to claim 1,
a) further including a system of satellites providing locating data; and,
b) wherein said means for identifying a location is responsive to signals from said system of satellites.

7. The communication system according to claim 6, wherein said mobile phone further includes:
a) a televison having,
1) means for tuning said television to a specific radio frequency,
2) means for receiving radio transmissions at said specific radio frequency,
3) visual and auditory means for communicating said radio transmissions to an operator of said mobile phone; and,
b) means for selecting said radio frequency based upon said area specific data

8. The communication system according to claim 6, wherein said mobile phone further includes:
a) a radio having,
1) means for tuning said radio to a specific radio frequency,
2) means for receiving radio transmissions at said specific radio frequency,
3) auditory means for communicating said radio transmissions to an operator of said mobile phone; and,
b) means for selecting said radio frequency based upon said area specific data.

9. The communication system according to claim 1,
a) wherein said area specific data includes location data of specific physical sites; and,
b) wherein said mobile phone includes,
1) based upon said location data and the location of said mobile phone, means for generating a map from the location of said mobile phone to the specific physical site, and,
2) means for communicating said map to a user of said mobile phone.

10. The communication system according to claim 1, wherein said mobile phone includes:
a) translation means for translating a user's language to one of several foreign languages; and,
b) means for choosing a single one of several foreign languages based upon the location of said mobile phone.

10. A mobile phone comprising:
a) means for identifying a location of said mobile phone, and,
b) means for selectively withdrawing area specific data being specific to the location of said mobile phone data from a data storage means via a communication network.

11. The mobile phone according to claim 10 wherein said mobile phone further includes:
a) means for matching, based upon said area specific data, an operator generated input to a desired area specific data value within said area specific data; and,
b) means for communicating said area specific value to a remote location via said communication network.

12. The mobile phone according to claim 10 wherein said mobile phone further includes:
a) a televison having,
1) means for tuning said television to a specific radio frequency,
2) means for receiving radio transmissions at said specific radio frequency,
3) visual and auditory means for communicating said radio transmissions to an operator of said mobile phone; and,
b) means for selecting said radio frequency based upon said area specific data.

13. The mobile phone according to claim 10 wherein said mobile phone further includes:
a) a radio having,
1) means for tuning said radio to a specific radio frequency,
2) means for receiving radio transmissions at said specific radio frequency,
3) auditory means for communicating said radio transmissions to an operator of said mobile phone; and,
b) means for selecting said radio frequency based upon said area specific data.

14. The mobile phone according to claim 10
a) wherein said area specific data includes location data of specific physical sites; and,
b) wherein said mobile phone includes,
1) based upon said location data and the location of said mobile phone, means for generating a map from the location of said mobile phone to the specific physical site, and,
2) means for communicating said map to a user of said mobile phone.

15. A wireless communication system comprising:
a) a communication network communicating messages between phones, said network having data storage means having area specific data being specific to specific locales stored therein; and,
b) a mobile phone having means for identifying a location of said mobile phone, and, means for selectively withdrawing the data associated with the location of said mobile phone from the data storage means.

16. The wireless communication system according to claim 15 wherein said mobile phone includes means for communicating with a computer secured to a vehicle.

17. The wireless communication system according to claim 16, wherein said mobile phone includes means for storing data within a memory of the computer secured to a vehicle.

18. The wireless communication system according to claim 15 wherein said mobile phone further includes:
a) a televison being responsive to a selectable radio frequency: and,
b) means for selecting said radio frequency based upon said area specific data.

19. The wireless communication system according to claim 15, wherein said mobile phone farther includes:
a) a radio being responsive to a selectable radio frequency; and,
b) means for selecting said radio frequency based upon said area specific data.
